(19) United States
(12) Patent Application Publication
(10) Pub. No.: US 2023/0371538 A1
(43) Pub. Date: Nov. 23, 2023

(54) PROCESS FOR PREPARING SHELF-STABLE PLANT-BASED FERMENTED DAIRY DRINK ANALOGUES AND SHELF-STABLE PLANT-BASED FERMENTED DAIRY DRINK ANALOGUES THEREOF

(71) Applicant: SOCIETE DES PRODUITS NESTLE S.A., Vevey (CH)

(72) Inventors: ANNE ROHART, Chateaurenard (FR); VIRGINIE MARTINET, Utzigen (CH)

(21) Appl. No.: 18/246,553

(22) PCT Filed: Sep. 23, 2021
(86) PCT No.: PCT/EP2021/076207

§ 371 Date: Mar. 24, 2023

(30) Foreign Application Priority Data
Sep. 25, 2020 (EP) 20198536.3

(51) Int. Cl. A23C 11/10; A23L 29/231; A23L 33/185; A23L 25/00

(52) U.S. Cl. CPC A23C 11/106; A23L 29/231; A23L 33/185; A23L 25/40

(57) ABSTRACT

A process for preparing a shelf-stable plant-based fermented dairy drink analogue is disclosed. A plant-based food composition comprising a hydrophilic liquid, a fermentable sugar and from 0.5 wt % to 3.4 wt % of plant proteins is first provided. Thereafter, the plant-based food composition is homogenized and heat treated. The heat-treated and homogenized plant-based food composition is then inoculated with at least one starter culture. The inoculated plant-based food composition is afterwards fermented until reaching a pH from 3.0 to 5.0 to obtain a plant-based fermented dairy drink analogue. Finally, the obtained plant-based yogurt analogue undergoes a second heat treatment to obtain a shelf-stable plant-based fermented dairy drink analogue. A shelf-stable plant-based fermented dairy drink analogue obtained by such a process and a food product comprising said plant-based fermented dairy drink analogue are also disclosed.

### TECHNICAL FIELD

The present invention relates generally to the field of plant-based fermented dairy drink analogues. In particular, the present invention relates to a process for preparing a shelf-stable plant-based fermented dairy drink analogue and a shelf-stable plant-based fermented dairy drink analogue obtained by such a process.

### BACKGROUND OF THE INVENTION

Nowadays, more and more consumers are following alternative diets such as veganism, vegetarism, flexitarism and dairy-free diets. The vegan, vegetarian, flexitarian and dairy-free diets imply, to different extents, the consumption of food products of non-animal origin, including non-dairy food products. Food companies meet this new demand by offering food products of non-animal origin, including non-dairy food products. The amount of non-dairy food products on the market, including plant-based fermented dairy drink analogues, is continuously growing.

A major part of the plant-based fermented dairy drink analogues, especially plant-based drinkable yogurt analogues, on the market contain a plurality of thickening agents or soy-based ingredients. However, excessive list of thickening agents and soy-based ingredients are rejected by consumers for transparency, health, nutritional and sustainability reasons.

In addition, the plant-based fermented dairy drink analogues on the market shall be stored under chilled conditions, that-is-to-say at a temperature of 1° C. to 10° C. and have a shelf-life of 30 days under chilled conditions. However, such chilled plant-based fermented dairy drink analogues may not be convenient for the consumers because they have a limited shelf-life of several days and cannot be safely taken away or stored in shelves without the need of a cold storage. They shall be stored under chilled condition (e.g. in a fridge) and shall be directly consumed after taking it out of the fridge to avoid any sanitary and hygienic risks.

Moreover, the manufacture of shelf-stable plant-based fermented dairy drink analogues involves a second heat-treatment after fermentation. This second heat-treatment provides drawbacks in relation to the fermented dairy drink, especially drinkable yogurts, such as the generation of off-flavours, a loss of texture, the formation of serum, the appearance of separation of phases, the appearance of sedimentation/settling phenomenon, and the appearance of an unpleasant granular texture due to protein aggregation. Separation of phase, protein aggregation and sedimentation/settling are even more disadvantageous when the fermented dairy drink is packaged into a container with a restricted headspace, especially a single serve container, more especially a single serve carton container. Indeed, when the container comprises a restricted headspace, it does not enable a proper homogenization of the product through shaking to mix the separate phases together. Hence, when drinking with a straw, the straw sucks up first the sediments at the bottom of the container. The sediments may obstruct the straw and moreover, as the product is not homogeneous due to settling, the sensory experience is unpleasant. Hence, it is important that the product remains homogenous and stable (i.e. no separation of phases, protein aggregation, sedimentation and settling) over its shelf-life.

Chilled plant-based spoonable yogurt analogues are known and disclosed in the prior art documents, but no shelf-stable plant-based fermented dairy drink analogue are disclosed.

WO2017/153669A1 (Roquette Frères) relates to a nutritional composition, for example a yogurt, comprising a pea protein isolate. The pea protein isolate has between 0.5% and 2% of free amino acids. The pea protein isolate also has a viscosity of 13 to 16.10−3 Pa·s at a shear rate of 10 s−1, of 10 to 14.10−3 at a shear rate of 40 s−1, and of 9.8 to 14.10−3 Pa·s at a shear rate of 600 s−1. Moreover, the pea protein isolate has a solubility of 30 to 40% in pH ranging from 4 to 5 and a solubility of 40 to 70% in pH ranging from 6 to 8. Example 7 discloses the preparation of a stirred yogurt with such a pea protein isolate. After fermentation, the yogurt is smoothed and stored at 4° C. The obtained stirred yogurt comprises modified starch and dairy proteins in addition to pea proteins.

WO2017/185093A1 (Ripple Foods, PBC) relates to non-dairy yogurt analogues having qualities similar to dairy-based yogurts. The non-dairy yogurt analogues analogues comprise at least one of between 1% to 10% by weight of a plant protein, and between 1%>to 90% by weight of a plant protein isolate.

WO2019/180037A1 (Cosucra Groupe Warcoing S.A.) relates to a kit for the preparation of a non-dairy vegetable-based yogurts. The kit contains a first powder portion comprising vegetable proteins and optionally a non-dairy food ingredient different from a protein. The kit contains a second powder portion comprising ferments, carbohydrates and an element selected from the group consisting of flavours, soluble fibres and mixtures thereof. This document discloses a process for manufacturing a vegetable-based yogurt with said kit. After mixing the two powders, the mixture is fermented by placing it in a temperature-controlled chamber until reaching a pH below 5. After fermentation, the obtained non-dairy vegetable-based yogurt is stored in a fridge till consumption.

WO2019/069111A1 (Yoplait France S.A.S.) relates to a method of making non-dairy fermented food products having substantially no added stabilizers, a viscosity of at least 0.4 Pa·s at 60 s−1 at 10° C. and a firmness of at least 40 g at 10° C. The method disclosed comprises the step of providing a liquid mixture comprising 3% to 12% of pea proteins and sugar and heating this liquid mixture at a temperature between 65° C. and 120° C. The method further comprises the step of inoculating the liquid mixture with a lactic acid bacterial culture and fermenting the liquid mixture to reach a pH of less than 4.7 to obtain a non-dairy fermented food product.

However, none of the products disclosed in the foregoing documents are suitable to be stored under ambient conditions for several months while keeping a satisfactory texture, taste and microbial load over the shelf-life. Especially, the pre-cited destabilisation phenomenon, including the separation of phases and aggregation of the plant proteins upon heat treatment, after fermentation, at high temperatures cannot be controlled, limited or even avoided in the prior art. This generates final products with unpleasant taste, insufficient texture and mouthfeel and an unpleasant sandy, grainy and/or gritty texture in mouth.

Hence, there is a need to provide shelf-stable plant-based fermented dairy drink analogues, especially shelf-stable plant-based drinkable yogurt analogues, preferably with a significant amount of proteins, that have a shelf-life of several months under ambient conditions (i.e. from 20° C. to 35° C.). Especially, there is a need for the shelf-stable plant-based fermented dairy drink analogues, especially shelf-stable plant-based drinkable yogurt analogues, having a homogeneous and stable texture over its shelf-life (i.e no settling/sedimentation and separation of phase), a smooth texture over its shelf-life (i.e. no protein aggregation) and a satisfactory consistency. Moreover, the shelf-stable plant-based fermented dairy drink analogues, especially shelf-stable plant-based drinkable yogurt analogues, should have limited off-notes.

Any reference to prior art documents in this specification is not to be considered an admission that such prior art is widely known or forms part of the common general knowledge in the field.

### SUMMARY OF THE INVENTION

The object of the present invention is to improve the state of the art, and in particular to provide a process that overcomes the problems of the prior art and addresses the needs described above, or at least to provide a useful alternative.

Accordingly, the invention provides a process for preparing a shelf-stable plant-based fermented dairy drink analogue, which comprises the steps of:
(a) providing a plant-based food composition comprising a hydrophilic liquid, a fermentable sugar, and plant proteins, wherein said plant-based food composition comprises from 0.5 wt % to 3.4 wt % of plant proteins, wherein the plant-based food composition is free from soy and dairy components,
(b) homogenizing the plant-based food composition at a pressure above 50 bar,
(c) heat-treating the plant-based food composition at a temperature from 80° C. to 100° C. for 1 minute to 10 minutes,
(d) inoculating the heat-treated and homogenized plant-based food composition with at least one starter culture to obtain an inoculated plant-based food composition,
(e) fermenting the inoculated plant-based food composition until reaching a pH from 3.0 to 5.0, preferably from 3.5 to 4.5, to obtain a plant-based fermented dairy drink analogue,
(f) heat-treating the plant-based fermented dairy drink analogue at a temperature from 75° C. to 125° C. for 3 seconds to 90 seconds to obtain a shelf-stable plant-based fermented dairy drink analogue,
   wherein the process comprises a step of addition of pectin, preferably high methoxyl pectin, into the plant-based food composition and/or the plant-based fermented dairy drink analogue after step (b) and before step (f).

Preferably, the plant-based food composition comprises from 1 wt % to 10 wt % of fermentable sugar, preferably sucrose.

In an embodiment, the plant proteins are pulse proteins, preferably pea proteins or fava bean proteins or a combination thereof.

Preferably, the at least one starter culture comprises at least one lactic acid-producing bacteria, preferably the at least one lactic acid-producing bacteria is selected from the group consisting of: Lactobacillus, Leuconostoc, Pediococcus, Lactococcus, Streptococcus, Bifidobacterium, Carnobacterium, Oenococcus, Sporolactobacillus, Tetragenococcus, Vagococcus, Weissella, and a combination thereof, preferably selected from the group consisting of Lactobacillus, Lactococcus, Streptococcus, Bifidobacterium and a combination thereof, further preferably selected from the group Lactobacillus, Streptococcus, Bifidobacterium and a combination thereof, most preferably Streptococcus, Lactobacillus and a combination thereof.

In an embodiment, the starter culture further comprises:

at least one yeast, preferably selected from the group consisting of: Zygosaccharomyces, Candida, Kloeckera/Hanseniaspora, Torulaspora, Pichia, Brettanomyces/Dekkera, Saccharomyces, Lachancea, Saccharomycoides, Schizosaccharomyces, and Kluyveromyces, most preferably Saccharomyces and Kluyveromyces,
and/or at least one acetic acid-producing bacteria, preferably selected from the group consisting of Acetobacter and Gluconacetobacter.

Preferably, the pectin is added such that plant-based food composition and/or the plant-based fermented dairy drink analogue comprises from 0.05 wt % to 1.0 wt % of pectin, preferably high methoxyl pectin.

Preferably, the pectin is added between steps (c) and (d) or between steps (e) and (f).

Preferably, the process does not comprise a step of addition of any added thickening agents, except pectin, especially high methoxyl pectin.

Preferably, the shelf-stable plant-based fermented dairy drink analogue has a shelf-life of at least 3 months, preferably at least 6 months, more preferably at least 9 months, most preferably at least 12 months, at a temperature of 20° C. to 40° C.

In an embodiment, the shelf-stable plant-based fermented dairy drink analogue has a viscosity of at least 50 mPa·s at 100 s−1 at 10° C., measured by means of a rheometer with plate-plate geometry (60 mm diameter) and with 1 mm gap.

The invention also provides a shelf-stable plant-based fermented dairy drink analogue obtained by the above-mentioned process.

The invention also provides a shelf-stable plant-based fermented dairy drink analogue, wherein said shelf-stable plant-based fermented dairy drink analogue is free from soy and dairy components and said shelf-stable plant-based fermented dairy drink analogue comprises:
a hydrophilic liquid, preferably water or a non-soy plant-based liquid or a combination thereof,
a fermentable sugar, preferably sucrose,
plant proteins, preferably pulse proteins, more preferably pea proteins or fava bean proteins or a combination thereof,
   and said shelf-stable plant-based fermented dairy drink analogue has:
a pH of 3.0 to 5.0, preferably of 3.5 to 4.5,
from 0.5wt % to 3.4wt % of plant protein,
a shelf-life of at least 3 months, preferably at least 6 months, more preferably at least 9 months, at a temperature of 20° C. to 35° C.

In an embodiment, the shelf-stable plant-based fermented dairy drink has a viscosity of at least 50 mPa·s at 100 s−1 at 10° C., measured by means of a rheometer with plate-plate geometry (60 mm diameter) and with 1 mm gap.

In an embodiment, the shelf-stable plant-based fermented dairy drink analogue is substantially free, preferably entirely free, from any added thickening agents, except pectin, preferably high methoxyl pectin.

The invention also provides a food product which comprises a shelf-stable plant-based fermented dairy drink analogue as mentioned above.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows the visual aspect, especially structure, of the shelf-stable plant-based fermented dairy drink analogue variants without pectin (on the left: variant 7 “DSI High-no pectin”, on the right: variant 8 “DSI low-no pectin) after a storage of 2 months at room temperature.

FIG. 2 shows cryo scanning electron microscopy images exhibiting the microstructure of shelf-stable plant-based fermented dairy drink analogue variant 1 “DSI High-pectin-AFTER ferm” (B, on the right) and variant 5 (A, on the left). Scale of 5 μm.

FIG. 3 shows confocal laser scanning microscopy images exhibiting the microstructure (protein (P) in green, lipid (F) in red, colocation protein and lipid in yellow (F+P)) of shelf-stable plant-based fermented dairy drink analogue variant 1 “DSI High-pectin-AFTER ferm” (B, on the right) and variant 5 “DSI High-pectin-BEFORE homo” (A, on the left). Scale of 20 μm.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

As used in the specification, the term “substantially free” means that no more than 10 weight percent, preferably no more than 5 weight percent, and more preferably no more than 1 weight percent of the excluded material is present. In a preferred embodiment, “substantially free” means that no more than 0.1 weight percent of the excluded material remains. “Entirely free” typically means that at most only trace amount of the excluded material is present, and preferably, no detectable amount is present.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

The term “shelf-stable” refers to a food product having a shelf-life of at least one month, at least three months, preferably at least 6 months, more preferably at least 9 months, most preferably at least 12 months, at a temperature from 20° C. to 40° C., especially from 20° C. to 37° C., more especially from 20° C. to 35° C. or even more especially from 20° C. to 30° C.

The term “plant-based fermented dairy drink analogue” refers to a drinkable fermented edible food product which comprises ingredients of plant origin, which is free from dairy or soy ingredients, and which mimics the texture and the appearance of a fermented dairy drink, such as drinkable yogurts or kefir dairy drinks.

The term “plant-based fermented drinkable yogurt analogue” refers to a drinkable fermented edible food product which comprises ingredients of plant origin, which is free from dairy or soy ingredients, and which mimics the texture and the appearance of a drinkable yogurt.

The term “hydrophilic liquid” refers to an edible liquid which comprises at least 70% of water. Especially, the hydrophilic is not derived from milk or soy. For example, milk, dairy creams, soy cream or soy milk are excluded from this definition.

The term “animal component” refers to any ingredients, semi-finished products or finished products derived from an animal. It includes dairy component. Examples of animal component include fish, meat, blood, milk, egg, squid ink and ingredients derived thereof.

The term “dairy component” refers to any ingredients, semi-finished products or finished products derived from a non-human mammal milk. Examples of dairy components include whole milk, semi-skimmed milk, skimmed milk, milk powder, condensed milk, buttermilk, butter, cream, whey proteins, caseins, yogurts, ice-creams and mixtures thereof.

The term “soy component” refers to any ingredients, semi-finished products or finished products derived from soy. Examples of soy component include soy proteins, soybean milk, soy lecithin, soy cream, soy milk, soy yogurt, whole soybeans and mixtures thereof.

The term “pulse” refers to edible dried seeds of plants in the legume family. Pulses generally grow in pods and vary in terms of size, color & shape. The four most common pulses are beans, chickpeas, lentils and peas. Examples of lentils, as Lens Culinaris, include Beluga Lentils, Brown Lentils, French Green Lentils, Green Lentils and Red Lentils. Examples of beans, as Phaseolus Vulgaris, include Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Fava Beans, Large Lima Beans, Mung Beans, Pink Beans, Pinto Beans, Romano Beans, Scarlet Runner Beans, Tongue of Fire, White Kidney Beans and White Navy Beans. Examples of peas include Black-Eyed Peas, Green Peas, Marrowfat Peas, Pigeon Peas, Yellow Peas and Yellow-Eyed Peas. Examples of chickpeas, as Cicer Arietinum, include Chickpea and Kabuli.

The term “added thickening agents” refers to agents that increase the viscosity of a food product. They may also be used to protect the proteins and prevent their aggregation after a heat treatment. It includes gums, starches and the like. For avoidance of doubt, this definition excludes pectin, the plant proteins, fermentable sugar or hydrophilic liquid. It also excludes the naturally-occurring thickening agents that could be naturally present in the ingredients of the shelf-stable plant-based fermented dairy drink analogue.

The term “high methoxyl pectin” is a pectin having a degree of esterification (DE) of at least 50%, preferably from 55% to 75%. The degree of esterification (DE) is defined as the number of methyl-esterified galacturonic acid units expressed as a percentage of the total galacturonic acid units in the pectin molecule.

In a first aspect, the invention relates to a process for preparing a shelf-stable plant-based fermented dairy drink analogue.

Especially, the shelf-stable plant-based fermented dairy drink analogue is selected from the list consisting of shelf-stable plant-based fermented milk analogues, shelf-stable plant-based drinkable yogurt analogues, shelf-stable plant-based kefir dairy drink analogues and a combination thereof. More preferably, the shelf-stable plant-based fermented dairy drink analogue is a shelf-stable plant-based drinkable yogurt analogue.

Especially, the shelf-stable plant-based fermented dairy drink analogue is free from any dairy components. More generally, the shelf-stable plant-based fermented dairy drink analogue is preferably free from any animal components. In addition, the shelf-stable plant-based fermented dairy drink analogue is free from soy components. Indeed, soy & its derivatives (e.g. soy milk) are avoided by consumers due to the potential presence in soy plant materials of molecules considered as endocrine disruptors (e.g. phytoestrogens, isoflavones) or even due to their potential GMO origin.

In a first step, the process comprises a step of providing a plant-based food composition. Especially, the plant-based food composition comprises a hydrophilic liquid, a fermentable sugar, and plant proteins. Said plant-based food composition comprises from 0.5 wt % to 3.4 wt % of plant protein, preferably from 1.5 wt % to 3.4 wt % or from 1.5 wt % to 3.0 wt % or from 1.5 wt % to 2.6 wt %, more preferably from 1.9 wt % to 3.4 wt % or from 1.9 wt % to 3.0 wt %, most preferably from 1.9 wt % to 2.6 wt % of plant proteins and is free from soy and dairy components.

In a particular embodiment, the plant-based food composition is provided as a plant-based raw material or a plant-based premix already containing a hydrophilic liquid, a fermentable sugar, and plant proteins. By “plant-based raw material”, it is understood a crude or processed materials of plant origin which are staple materials to manufacture food products (e.g. coconut milk). A plant-based raw material shall not be a soy component or a dairy component. Preferably, the plant-based raw material shall not be an animal component. By “plant-based premix”, it is understood a composition prepared before its use by mixing raw materials, especially plant-based raw materials, and such a composition does not contain any soy components or dairy components. Preferably, such a composition does not contain an animal component. It is also preferred that such plant-based raw materials or plant-based premixes comprise from 0.5 wt % to 3.4 wt % of plant protein, preferably from 1.5 wt % to 3.4 wt % or from 1.5 wt % to 3.0 wt % or from 1.5 wt. % to 2.6 wt %, more preferably from 1.9 wt % to 3.4 wt % or from 1.9 wt % to 3.0 wt %, most preferably from 1.9 wt % to 2.6 wt % of plant proteins.

In an alternative embodiment, the plant-based food composition is prepared by mixing a hydrophilic liquid, a fermentable sugar, and plant proteins such that the plant-based food composition comprises from 0.5 wt % to 3.4 wt % of plant protein, preferably from 1.5 wt % to 3.4 wt % or from 1.5 wt % to 3.0 wt % or from 1.5 wt. % to 2.6 wt %, more preferably from 1.9 wt % to 3.4 wt % or from 1.9 wt % to 3.0 wt %, most preferably from 1.9 wt % to 2.6 wt of plant proteins. The food composition may be prepared by mixing additional ingredients (e.g. vitamins, minerals, oil, fibres . . . ) to the ones previously cited, provided that these additional ingredients are not or does not comprise dairy components or soy components. Preferably, the additional ingredient are not or does not comprise animal components. It is also preferred that the plant-based food composition is prepared such that the fermentable sugar(s), the plant proteins and the potential additional ingredient(s) are mixed together at their targeted concentrations and such that the plant-based food composition is complemented with the hydrophilic liquid(s) to reach 100 wt %. In this embodiment, the plant protein is provided via a plant protein preparation. A plant protein preparation is a composition comprising from 30.0 wt % to 95.0% of plant proteins. In a preferred embodiment, the plant protein preparation is a plant protein concentrate. The term “plant protein concentrate” refers to a composition comprising a non-soy plant protein content from 60% to 80%. In a more preferred embodiment, the plant protein preparation is a plant protein isolate. The term “plant protein isolate” refers to a composition comprising a non-soy plant protein content from 80.0% to 95.0%.

Details about the plant-based food composition and its components are provided below.

The plant-based food composition comprises a hydrophilic liquid. The hydrophilic liquid is water or a non-soy plant-based liquid or a combination thereof. By “non-soy plant-based liquid”, it is understood a non-dairy liquid composition, which may be a viscous liquid composition such as a cream, which is derived from an edible plant source (e.g. fruits, grains, nuts, pulses, seeds and the like) different from soy. The non-soy plant-based liquid may be a plant-based cream alternative, plant-based milk alternative, plant-based water and mixtures thereof. Examples of plant-based cream alternative include almond cream, cashew cream, coconut cream, hazelnut cream, peanut cream and mixtures thereof. Examples of plant-based milk alternative include almond milk, banana milk, cashew milk, chestnut milk, coconut milk, hazelnut milk, flaxseed milk, hemp seed milk, lupine milk, oat milk, peanut milk, pine nut milk, pistachio milk, rice milk, sesame seed milk, sunflower seed milk, walnut milk and mixtures thereof. Examples of plant-based water include coconut water. Preferably, the hydrophilic liquid is water or a plant-based milk alternative. More preferably, the plant-based milk alternative is selected from the group consisting of almond milk, cashew milk, coconut milk, hazelnut milk, oat milk, peanut milk and mixtures thereof. The hydrophilic liquid contributes to improve the nutritional profile and/or the organoleptic profile of the shelf-stable yogurt analogue.

The plant-based food composition comprises a fermentable sugar. By “fermentable sugar”, it is understood sugars of non-dairy origin, which are converted into acids upon fermentation by starter cultures. Lactose is excluded from this definition. The acid formation will promote the formation of a gel with a sufficient consistency by the coagulation of plant proteins into a plant protein network. The consistency of the obtained gel can mimic the consistency of standard fermented dairy drinks, such as drinkable yogurts. Especially, after fermentation, the final product may exhibit a liquid or semi-liquid texture with enhanced viscosity and mouthfeel. Examples of fermentable sugar include agave syrup, brown sugar, coconut sugar, corn syrup, dextrose, fructose, glucose, honey, invert sugar, maltose, molasse, sucrose, sugar-containing liquid, sugar-containing cream, sugar-containing paste and mixtures thereof. In a preferred embodiment, the fermentable sugar is sucrose.

In a preferred embodiment, the plant-based food composition comprises from 1 wt % to 10 wt % of fermentable sugar. More preferably, the plant-based food composition comprises from 2 wt % to 10 wt % of fermentable sugar. More preferably, the plant-based food composition comprises from 3 wt % to 10 wt % of fermentable sugar. Most preferably, the plant-based food composition comprises from 3 wt % to 8 wt % of fermentable sugar. Even most preferably, the plant-based food composition comprises from 3 wt % to 6 wt % of fermentable sugar. Such ranges guarantee an effective fermentation (i.e. low fermentation time to reach the targeted pH) and/or a good nutritional profile (i.e. not too high sugar content) at the same time.

The plant-based food composition comprises plant proteins. The term “plant proteins” refers to edible proteins originated from plant materials, which are different from soy. Especially, soy proteins are excluded from the scope of the invention. Indeed, as previously explained, soy and its derivatives (e.g. soy proteins) are avoided by consumers for the abovementioned reasons. The plant proteins of the invention shall coagulate and shall form a gel upon acidification, especially upon fermentation. Indeed, the formation of a gel participated in increasing the viscosity of the final product and in the end, it can enable to reach a range of textures that can mimic the textures of standard fermented dairy drink, such as drinkable yogurt. Especially, the final product may have a liquid or semi-liquid texture with enhanced viscosity and mouthfeel. Moreover, the final product has a liquid or semi-liquid texture, especially viscosity, that enables its consumption by mouth drinking and/or by sucking up with a straw or any other equivalent items.

The plant-based food composition comprises from 0.5 wt % to 3.4 wt % of plant protein, preferably from 1.5 wt % to 3.4 wt % or from 1.5 wt % to 3.0 wt % or from 1.5 wt. % to 2.6 wt %, more preferably from 1.9 wt % to 3.4 wt % or from 1.9 wt % to 3.0 wt %, most preferably from 1.9 wt % to 2.6 wt %. Without wishing to be bound by theory, these ranges of amount of plant proteins enables to reach a satisfactory texture upon acid gelation of plant proteins while minimizing protein precipitation. Above these ranges, the texture may not be suitable for drinking. In addition, these ranges of amount of plant protein, especially upper ranges, ensures an acceptable level of proteins for nutritional purposes.

In particular the plant-based food composition comprises 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt % of plant proteins. The obtained shelf-stable plant-based fermented dairy drink analogue has a texture mimicking the texture of standard fermented dairy drinks, such as drinkable yogurts.

In a more preferred embodiment, the shelf-stable plant-based fermented dairy drink analogue is a shelf-stable plant-based drinkable yogurt analogue and it comprises from 0.5 wt % to 3.4 wt % of plant protein, preferably from 1.5 wt % to 3.4 wt % or from 1.5 wt % to 3.0 wt % or from 1.5 w. % to 2.6 wt %, more preferably from 1.9 wt % to 3.4 wt % or from 1.9 wt % to 3.0 wt %, most preferably from 1.9 wt % to 2.6 wt % of plant proteins.

In a preferred embodiment, plant proteins are pulse proteins. Indeed, pulse proteins are preferred for the invention because they form a satisfactory gel upon acidification. Hence, upon acidification, pulse proteins can provide a range of textures that can mimic the texture of fermented dairy drink, such as drinkable yogurts. More preferably, pulse proteins are selected from the group consisting of bean proteins, chickpea proteins, fava bean proteins, lentil proteins, pea proteins, and mixtures thereof. Most preferably, the pulse proteins are selected from the group consisting of pea proteins, fava bean proteins and a combination thereof. Pulse proteins and Fava bean proteins are advantageous because they are able to provide satisfactory results in terms of gelation upon acidification. Especially they are able to achieve a range of textures, including thick textures, that can mimic the texture of fermented dairy drink, such as drinkable yogurts.

In a more preferred embodiment, pulse proteins are pea proteins. Pea proteins are the proteins that provide the most satisfactory results in terms of gelation upon acidification. Pea proteins, at a predetermined content and upon acid gelation, enable to mimic the texture of fermented dairy drinks, especially drinkable yogurts while providing reduced off-notes.

In a preferred embodiment, the plant-based food composition comprises a total protein content of at most 3.4 wt %, preferably of at most 3.0 wt %, more preferably of at most 2.6 wt %. Minimizing the protein content enables to limit, in a certain extent, the aggregation of proteins upon heat-treatment. This participates to achieve a plant-based fermented dairy drink analogue which is smooth in mouth and which does not exhibit an unpleasant sandy, grainy and/or gritty texture.

In a further embodiment, the plant-based food composition comprises a fat content from 0 wt % to 12.0 wt %. Preferably, the fat content ranges from 0 wt % to 10.0 wt %, from 0 wt % to 5.0 wt %, from 0.5 wt % to 2.5 wt % or from 0.5 wt % to 1.0 wt %. Most preferably, the fat content is of 0.9 wt %. In a preferred embodiment, the fat content consists essentially of vegetable fat. By “vegetable fat”, it is understood fat of non-soy plant origin. The presence of vegetable fat may participate in collaboration with the proteins to the texture of the final food product, especially by improving mouthfeel of the shelf-stable plant-based fermented dairy drink analogue.

In an additional embodiment, the plant-based food composition has a dry matter from 6 wt % to 20 wt %, preferably from 8 wt % to 20 wt %. More preferably, the dry matter is from 8 wt % to 15 wt %. Most preferably, the dry matter is from 11 wt % to 13 wt %. The dry matter, including the protein content, participates in the texture of the shelf-stable plant-based fermented dairy drink analogue.

In another embodiment, the plant-based food composition may further comprise algae flours, antioxidants, colours, edible plant oils, fibres, flavours, flower essences, fruit preparations, minerals, prebiotics, sauces, solid inclusions, spices, sweeteners, tea, vegetables and/or vitamins. The only condition is that these ingredients shall not be or shall not comprise a soy components or a dairy components. More preferably, these ingredients shall not be or shall not comprise animal components.

After providing the plant-based food composition, the process of the invention comprises a step of homogenizing the plant-based food composition at a pressure above 50 bar. Preferably, the homogenizing step is performed at a pressure from 50 bar to 700 bar. Further preferably, the homogenizing step is performed at a pressure from 50 bar to 500 bar. More preferably, the homogenizing step is performed at a pressure from 50 to 300 bar, from 100 to 300 bar or from 150 to 300 bar. Most preferably, the homogenizing step is performed at a pressure of 250 bar. Without wishing to be bound by theory, it is believed that the homogenizing step is an important step to functionalize the plant proteins. Indeed, the obtaining of a satisfactory texture resulting from the coagulation of plant proteins is only possible after performing a homogenizing step. In the absence of homogenization step, the plant proteins would not provide, upon acidification, a satisfactory texture. Especially, a satisfactory texture mimicking the texture of standard fermented dairy drink, such as drinkable yogurts, would not be reached.

In a preferred embodiment, the homogenization step is performed at a temperature from 50° C. to 70° C. More preferably, the homogenization step is performed at a temperature from 55° C. to 65° C. Most preferably, the homogenization step is performed at a temperature of 60° C.

After the homogenization step, the process according to the invention comprises a step of heat-treating the plant-based food composition at a temperature from 80° C. to 100° for 1 minute to 10 minutes. Preferably, the heat treatment is performed at a temperature from 85° C. to 95° C. for 3 minutes to 7 minutes. Preferably, the heat treatment is performed at a temperature of 92° C. for a time of 6 minutes. The heat treatment step is performed for hygiene and quality purposes. Indeed, this heat treatment prevents any development of unwanted micro-organisms in the plant-based fermented dairy drink analogue, such as bacteria or moulds that may affect negatively the organoleptic properties of the plant-based fermented dairy drink analogue, or that may be pathogenic. Moreover, without wishing to be bound by theory, it is believed that this heat treatment also participates in the functionalization of the plant proteins but to a lesser extent than the homogenization step. In particular, the heat treatment step participates to a certain extent in enhancing the gelling properties of plant proteins upon acidification. For example, the heat-treatment may be carried out in an indirect manner by means of a heat-plate exchanger. As a variant, it is possible to carry it out in a jacketed holding unit or direct steam injection.

The heat-treatment step may be performed prior or after the homogenization step. In a preferred embodiment, the heat-treatment is performed after the homogenization step. Indeed, for hygienic and manufacturing purposes, it is preferred that the heat-treatment is performed after the homogenization step. Indeed, it ensures the elimination of any unwanted micro-organisms that could be brought during the homogenization step, especially in the event where the homogenization step is performed with a non-aseptic homogenizing equipment. Moreover, in the event where the homogenization step is performed with a non-aseptic homogenizing equipment and is performed after the heat-treatment step, it would require to perform an additional heat-treatment after the homogenizing step. Such an additional heat-treatment makes the process more complex to be implemented. Moreover, it is desired to minimize the number of heat-treatments as heat-treatments may negatively impact the nutritional composition and sensory profile of the final product.

After the first heat-treatment step, the process comprises a step of inoculating the heat-treated and homogenized plant-based food composition with at least one starter culture. Especially, the starter culture is substantially free, preferably entirely free from dairy components or soy components.

In a preferred embodiment, the at least one starter culture comprises at least one lactic acid-producing bacteria. Especially, the at least one lactic acid-producing bacteria is selected from the group consisting of: Lactobacillus, Leuconostoc, Pediococcus, Lactococcus, Streptococcus, Bifidobacterium, Carnobacterium, Oenococcus, Sporolactobacillus, Tetragenococcus, Vagococcus, Weissella, and a combination thereof, preferably selected from the group consisting of Lactobacillus, Lactococcus, Streptococcus, Bifidobacterium and a combination thereof, further preferably selected from the group Lactobacillus, Streptococcus, Bifidobacterium and a combination thereof, most preferably Streptococcus, Lactobacillus and a combination thereof. More specifically, the starter culture may include for example one or more of the following lactic acid-producing bacteria: Lactobacillus acidophilus, Lactobacillus delbrueckii subsp. bulgaricus, Lactobacillus paracasei, Lactobacillus casei, Lactobacillus johnsonii, Lactobacillus plantarum, Lactobacillus sporogenes (or Bacillus coagulans), Streptococcus thermophilus, Streptococcus lactis, Streptococcus cremoris, strains from the genus Bifidobacterium and mixtures thereof.

In another embodiment, the starter culture further comprises:

at least one yeast, preferably selected from the group consisting of: Zygosaccharomyces, Candida, Kloeckera/Hanseniaspora, Torulaspora, Pichia, Brettanomyces/Dekkera, Saccharomyces, Lachancea, Saccharomycoides, Schizosaccharomyces, and Kluyveromyces, most preferably Saccharomyces and Kluyveromyces, and/or at least one acetic acid-producing bacteria, preferably selected from the group consisting of Acetobacter and Gluconacetobacter. These strains, in addition to lactic-acid producing strain, are used to produce kefir dairy drinks. Hence, by using these strains, the fermented dairy drink analogues of the invention can even more mimics kefir dairy drinks.

In a more preferred, the starter culture only consists of one or more lactic acid-producing bacteria. Preferably, the starter culture consists of one or more thermophilic lactic acid bacteria strains. The term “thermophilic lactic starter acid bacteria strains” refers to lactic acid bacteria strains having an optimal growth at a temperature between 36° C. and 45° C. More preferably, the starter culture is selected among the list consisting of: Lactobacillus delbrueckii subsp. bulgaricus, Lactobacillus paracasei, Lactobacillus acidophilus, Streptococcus thermophilus, Bifidobacterium species and a combination thereof. Most preferably, the starter consists of a combination of Lactobacillus delbrueckii subsp. bulgaricus and Streptococcus thermophilus. Especially, Lactobacillus delbrueckii subsp. bulgaricus and Streptococcus thermophilus are the two staple strains that are used in dairy drinkable yogurts. Hence, by using these strains, the fermented dairy drink analogues of the invention, especially the drinkable yogurt analogues is prepared with the same strains as the ones used to prepare drinkable yogurts.

After the inoculation step, the process according to the invention comprises a step of fermenting the inoculated plant-based food composition until reaching a pH from 3.0 to 5.0, preferably from 3.5 to 4.5, to obtain a plant-based fermented dairy drink analogue. During the fermentation step, the starter culture converts the fermentable sugar into acids. The formation of acids promotes the formation of a gel, especially a fluid, with a sufficient consistency by the coagulation of plant proteins into a plant protein network. The consistency of the obtained fluid can mimic the consistency of standard fermented dairy drinks, such as drinkable yogurts. Moreover, the fermentation enables to improve the taste of the shelf-stable plant-based fermented dairy drinks. Without wishing to be bound by theory, the inventors believe fermentation decreases off-notes brought by plant-based materials, such as plant proteins.

In a further embodiment, the fermentation step is performed at the temperature of optimal growth of the starter culture. The temperature of optimal growth of the starter culture may be easily determined by the person skilled in the art. Preferably, the fermentation step is performed at temperature from 15° C. and 45° C. More preferably, the fermentation step is performed at a temperature from 20° C. to 45° C. or from 25° C. to 45° C. Most preferably, the fermentation step is performed from 36° C. to 45° C. When the starter culture comprises yeast, the fermentation step may be performed between 15° C. and 30° C., preferably between 20° C. and 25° C.

The process of the invention comprises a second heat treatment after the fermentation step. Especially, the process comprises a step of heat treating the plant-based fermented dairy drink analogue at a temperature from 75° C. to 125° C. for 3 seconds to 90 seconds to obtain a shelf-stable plant-based fermented dairy drink analogue. Preferably, the heat treatment is performed at a temperature from 80° C. to 125° C. for 3 seconds to 90 seconds. Most preferably, the heat treatment is performed at a temperature of 120° C. for a time of 3 seconds.

The second heat treatment enables to considerably extend the shelf-life of the shelf-stable plant-based fermented dairy drink analogue, especially the shelf-life is extended to at least 1 month, at least 3 months, preferably at least 6 months, more preferably at least 9 months, most preferably at least 12 months and the product may be stored at ambient temperatures (i.e. between 20° C. and 40° C., preferably between 20° C. and 37° C., more preferably between 20° C. and 35° C. or even more preferably between 20° C. and 30° C.) without involving sanitary risks. The obtained shelf-stable plant-based fermented dairy drink analogue is more convenient for the consumer than a chilled plant-based fermented dairy drink analogue. Indeed, the shelf-stable plant-based fermented dairy drink analogue may be safely taken away or stored in shelves without the need of a cold storage at a temperature between 1° C. and 10° C.

It is known for fermented dairy drinks that the protein network formed after fermentation is very sensitive, especially sensitive to heat treatment. The person skilled in the art knows that applying a heat treatment after fermentation often leads, in fermented dairy drink, to an undesirable aggregation of the proteins, to a sedimentation, to a separation of phases, and leads to a significant loss of texture. The loss of texture may lead to an unsatisfactory texture, especially, a texture far from which can be expected for fermented dairy drink, especially drinkable yogurts. The separation of phases leads to an unattractive heterogeneous aspect and to an unpleasant sensory experience. The aggregation of proteins and the sediments generates an unpleasant sandy and grainy/gritty texture in mouth and in certain case, to an unattractive aspect by the appearance of grains into the fermented dairy drink.

To avoid the foregoing, the inventors have discovered that a single thickening agent may be used, especially pectin, before the second heat treatment to compensate the weak texture, to protect the proteins from the second heat treatment and improve the stability of the shelf-stable plant-based fermented dairy drink analogue.

By using pectin alone, preferably high methoxyl pectin alone, it has been found that a second treatment after fermentation does not lead to an aggregration of the plant proteins. Moreover, despite a loss of texture, a shelf-stable plant-based fermented dairy drink analogue having a satisfactory texture may be achieved with the sole presence of pectin as thickening agent. Especially, the shelf-stable plant-based fermented dairy drink analogue has a homogeneous texture and does not exhibit sedimentation and separation of phases phenomenon.

Especially, the process comprises a step of addition of pectin, preferably high methoxyl pectin, into the plant-based food composition and/or the plant-based fermented dairy drink analogue after step (b) (i.e the homogenization step) and before step (f) (i.e the second heat-treatment step).

The inventors have discovered that pectin shall be added after the homogenization step (ie. after step (b)) to obtain an optimal texture. Indeed, when the pectin is added before homogenization, the final product exhibits a lower texture, especially a lower viscosity than obtained when the pectin addition is after the homogenization step. Hence, the obtained texture may be unsatisfactory and may be insufficient to mimic the texture of some standard fermented dairy drinks, in particular drinkable yogurts. It is also important that the pectin is added before the second heat-treatment (i.e before step (f)) to ensure pectin protects plant proteins and the final product from destabilisation phenomena (e.g protein aggregation) upon or subsequent to the second heat treatment.

In a preferred embodiment, the pectin is citrus high methoxyl pectin.

More preferably, the pectin, preferably high methoxyl pectin, is added such that plant-based food composition and/or the plant-based fermented dairy drink analogue comprises from 0.05 wt % to 1.0 wt % of pectin, preferably high methoxyl pectin. Within this range, pectin protects plant proteins from the second heat-treatment and limits destabilisation phenomena within the final product such as protein aggregation, separation of phases, sedimentation, settling and loss of texture. Moreover, without wishing to be bound by theory, the inventors believe pectin would be able to limit the acidity (perceived in mouth) of the final product over the shelf-life.

In a specific embodiment, the pectin is added between steps (c) (ie. first heat-treatment step) and (d) (ie. inoculation step) or between steps (e) (i.e. fermentation step) and (f) (i.e. second heat-treatment step). Preferably, the process comprises a step of smoothing the plant-based fermented dairy drink analogue between steps (e) and (f). Especially, in a preferred embodiment, the pectin is added just before a smoothing step between steps (e) and (f). The smoothing step may be performed with a rotor stator smoothing device as described in EP1986501 A1. Moreover, the smoothing step may be performed with a Ytron smoothing device at a rotation speed of from 20 Hz to 60 Hz, preferably from 20 Hz to 40 Hz, most preferably from 25 Hz to 35 Hz. The smoothing step enables to smooth and homogenize the gel obtained after fermentation into a homogenous fluid having no or limited grainy texture. Especially, the smoothing device shall minimize the loss of viscosity that is subsequent to smoothing step. Hence, a fluid with a satisfactory texture, especially viscosity and mouthfeel, is obtained. Moreover, the smoothing step enables to ensure a good incorporation of pectin and maximize its thickening and protective properties.

In a particular embodiment, the pectin is a pectin solution. Especially, the pectin, preferably high methoxyl pectin, is hydrated into warm water to prepare a pectin solution. This step is prior its addition into the plant-based food composition and/or the plant-based fermented dairy drink analogue. By “warm water”, it is understood a water having a temperature between 70° C. and 80° C., preferably between 70° C. and 75° C. The temperature of the pectin solution should remain between 70° C. and 80° C., preferably between 70° C. and 75° C. before its addition into the plant-based food composition and/or the plant-based fermented dairy drink analogue. The concentration of pectin, preferably high methoxyl pectin, within the pectin solution may be determined by the persons killed in the art depending on the application, the pectin characteristics and the equipment. Whatever its pectin concentration, the pectin solution shall be added at a sufficient amount to reach a content of 0.05 wt % to 1.0 wt %, preferably of 0.1 wt % to 1.0 wt %, preferably of 1 wt % to 1.0 wt % or from 0.5 wt % to 1.0 wt % of pectin, preferably high methoxyl pectin, within the plant-based food composition and/or the plant-based fermented dairy drink analogue.

The process does not comprise a step of addition of any added thickening agents, except pectin, preferably high methoxyl pectin. Examples of added thickening agents include acacia gum, agar, alginate, carrageenan, gellan, locust bean gum, starch, xanthan gum, and mixtures thereof. In the present context, the term “starch” includes ingredients consisting only of starch but also includes wheat flours, tapioca flours and corn flours. In particular the shelf-stable plant-based fermented dairy drink analogue is substantially free, preferably entirely free from any added thickening agents, except pectin, preferably high methoxyl pectin. Despite the second heat treatment, the shelf-stable plant-based fermented dairy drink analogue has a satisfactory smooth and thick texture and no protein aggregation or any other destabilisation phenomena are observed, even when pectin, especially high methoxyl pectin, is used alone without any other added thickening agents.

In an embodiment, the process does not comprise any step consisting of ultrasound processing, pulsed light treatment and/or ultra high pressure homogenization (UHPH). Ultra high pressure homogenization corresponds to an homogenization step which is performed at a pressure of at least 50 MPa, preferably at a pressure of 50 MPa to 500 MPa, more preferably at a pressure of 200 MPa to 400 MPa. Ultrasound processing, pulsed light treatment and ultra high pressure homogenization are mild technologies, in particular low temperature technologies, that enable to extend the shelf-life of a food while limiting stability issues (e.g. separation of phase such as creaming, sedimentation, protein aggregation etc. . . . ) related to high temperature heat-treatment, such as sterilization. The inventors have discovered that the process of the invention enables to provide shelf-stable plant-based fermented dairy drink analogues having an extended shelf-life and having good stability (e.g. limited separation of phase such as creaming, limited sedimentation, limited protein aggregation etc. . . . ) without using any of the precited mild technologies, which may be expensive and hard to implement at an industrial scale. In particular, such a drink analogue with extended shelf-life and good stability may be achieved even by using a high temperature heat-treatment (cf. step (f)) after the fermentation step in the process of the invention.

In a preferred embodiment, the process comprises a step of mixing the plant-based fermented dairy drink analogue with a fruit preparation, preferably a fruit puree, more preferably a banana puree. This mixing step is prior step (f) (i.e. prior the second heat treatment) and is subsequent to step (e) (i.e. subsequent to the fermentation step), preferably subsequent to the smoothing step, if any.

In a more preferred embodiment, the fruit preparation is mixed with the plant-based fermented dairy drink analogue such that the plant-based fermented dairy drink analogue comprises 5-50 wt % fruit preparation, preferably 10-40 wt % fruit preparation, more preferably 15-30 wt %, most preferably 15-26 wt %. Preferably, the fruit preparation is a fruit puree, more preferably a banana puree.

In a particular embodiment, the fruit puree, more preferably the banana puree, has from 10° to 30° Brix, preferably from 20° to 30° Brix, more preferably from 22° to 26° Brix.

In another embodiment, the process comprises a step of addition of a food-grade acidic compound, preferably lactic acid, to the plant-based fermented dairy drink analogue to reach a pH between 3.0 to 5.0, preferably between 3.5 to 4.5. By acidic compound, it is understood a food-grade ingredient that is able to decrease the pH. This step of addition of a food-grade acidic compound is prior step (f) (i.e. prior the second heat treatment and is subsequent to step (e) (i.e. subsequent to the fermentation step), preferably subsequent to the smoothing step (if any), more preferably subsequent to the step of mixing the plant-based fermented dairy drink analogue with a fruit preparation (if any).

Thanks to the second heat treatment after fermentation, the shelf-stable plant-based fermented dairy drink analogue has a shelf-life of at least 1 month, at least 3 months preferably at least 6 months, more preferably at least 9 months most preferably at least 12 months, at a temperature of 20° C. to 40° C., preferably of 20° C. to 37° C., more preferably of 20° C. to 35° C. or even more preferably of 20° C. to 30° C. . In another embodiment, the shelf-stable plant-based fermented dairy drink analogue has a shelf-life of 1 month, 2 months, 3 months, 6 months, 9 months or 12 months at a temperature of 20° C. to 40° C., preferably of 20° C. to 37° C., more preferably of 20° C. to 35° C. or even more preferably of 20° C. to 30° C. In another embodiment, the shelf-stable plant-based fermented dairy drink analogue has a shelf-life of at least 1 month, preferably at least 3 months at a temperature of 20° C. to 40° C., preferably of 20° C. to 37° C., more preferably of 20° C. to 35° C., even more preferably of 20° C. to 30° C. and at a relative humidity of 60% to 75%. In another embodiment, the shelf-stable plant-based fermented dairy drink analogue has a shelf-life of at least 6 months, more preferably at least 9 months, most preferably at least 12 months, at a temperature of 20° C. to 40° C., preferably of 20° C. to 37° C., more preferably of 20° C. to 35° C., even more preferably of 20° C. to 30° C. and at a relative humidity of 60% to 75%. The relative humidity may be measured with a hygrometer, for example a psychometrer or a wet-and-dry-bulb thermometer.

The shelf-stable plant-based fermented dairy drink analogue has a texture (i.e. viscosity) that enables its consumption by mouth drinking and/or by sucking up with a straw or any other equivalent items. Preferably, it has a texture (i.e. viscosity) that can mimic the texture of standard fermented dairy drinks, such as drinkable yogurts.

Especially, in an embodiment, the shelf-stable plant-based fermented dairy drink analogue has a viscosity of at least 50 mPa·s at 100 s⁻¹ at 10° C., preferably of at least 60 mPa·s at 100 s⁻¹ at 10° C. or of at least 70 mPa·s at 100 s⁻¹ at 10° C. More preferably, the shelf-stable plant-based fermented dairy drink analogue has a viscosity of at least 80 mPa·s at 100 s⁻¹ at 10° C. or of at least 90 mPa·s at 100 s⁻¹ at 10° C. Most preferably, the shelf-stable plant-based fermented dairy drink analogue has a viscosity of at least 100 mPa·s at 100 s⁻¹ at 10° C. Especially, the shelf-stable plant-based fermented dairy drink analogue has a viscosity ranging from 50 mPa·s to 390 mPa·s at 100 s⁻¹ at 10° C., preferably from 50 mPa·s to 350 mPa·s, from 60 mPa·s to 350 mPa·s, from 70 mPa·s to 390 mPa·s, from 80 mPa·s to 350 mPa·s or from 90 mPa·s to 350 mPa·s at 100 s⁻¹ at 10° C. More preferably, the shelf-stable plant-based fermented dairy drink analogue has a viscosity ranging from from 90 mPa·s to 300 mPa·s, preferably from 90 mPa·s to 200 mPa·s at 100 s⁻¹ at 10° C.

The viscosity is measured at 7 days after fermentation on samples of the shelf-stable plant-based fermented dairy drink analogue. First, the sample of the shelf-stable plant-based fermented dairy drink analogue is stored at a temperature of 10° C. for a minimum of 2 hours prior to measurement. Then, the sample is gently stirred in a circular motion 3 times before transferring to Rheometer Haake RS600 (ThermoFisher Scientific, Waltham, Massachusetts, United-States) with plate/plate geometry (60 mm diameter), especially plate/plate geometry PP60, and with 1 mm gap. Flow curves with controlled shear rate ramp from 0 to 300 s⁻¹ (linear increase) may be obtained at 10° C.+/−0.1. Especially, the viscosity is measured using Rheowin software (ThermoFisher Scientific, Waltham, Massachusetts, United-States) in terms of Pa*s at 100 s⁻¹ at 10° C.

In a further embodiment, the shelf-stable plant-based fermented dairy drink analogue comprises a fat content from 0 wt % to 12 wt %. Preferably, the fat content ranges from 0 wt % to 10 wt %, from 0 to 5.0 wt %, from 0.5 wt % to 2.5 wt % or from 0.5 wt % 1.0 wt. Most preferably, the fat content is of 0.9 wt %. In a preferred embodiment, the fat content consists essentially of vegetable fat.

In a further embodiment, the shelf-stable plant-based fermented dairy drink analogue has a dry matter from 6 wt % to 20 wt %, preferably from 8 wt % to 20 wt %. More preferably, the dry matter is from 8 wt % to 15 wt %. Most preferably, the dry matter is from 11 wt % to 13 wt %. The dry matter, including the protein content, participates in the texture of the final fermented dairy drink analogue.

The process may further comprise a step of mixing the shelf-stable plant-based fermented dairy drink analogue with additional ingredients such as antioxidants, algae flours, antioxidants, cocoa, colours, edible plant oils, fibres, flavours, flower essences, fruits, fruit preparations, minerals, probiotics, probiotics, sauces, solid inclusions, spices, sweeteners, vegetables and/or vitamins

For the avoidance of doubt, analogously to the plant-based food composition and to the plant-based fermented dairy drink analogue, the shelf-stable plant-based fermented dairy drink analogue comprises a hydrophilic liquid, a fermentable sugar, and plant proteins. Especially, the shelf-stable plant-based fermented dairy drink analogue comprises from 0.5 wt % to 3.4 wt % of plant protein, preferably from 1.5 wt % to 3.4 wt % or from 1.5wt % to 3.0 wt % or from 1.5 w. % to 2.6 wt %, more preferably from 1.9 wt % to 3.4 wt % or from 1.9 wt % to 3.0 wt %, most preferably from 1.9 wt % to 2.6 wt % of plant proteins and it is free from soy and dairy components.

Especially, in a preferred embodiment, the shelf-stable plant-based fermented dairy drink analogue comprises a total protein content of at most 3.4 wt %, preferably of at most 3.0 wt %, more preferably of at most 2.6 wt %. Minimizing the protein content enables to limit, in a certain extent, the aggregation of proteins upon heat-treatment. This participates to achieve a plant-based fermented dairy drink analogue which is smooth in mouth and which does not exhibit an unpleasant sandy, grainy and/or gritty texture.

In a preferred embodiment, the shelf-stable plant-based fermented dairy drink analogue does not have a grainy or gritty texture. By “grainy or gritty texture”, it means a texture characterized by grains discernible in mouth upon tasting and/or discernible upon visual inspection. The grainy/gritty texture of a food product, including drinks, may be assessed by a panel which has been trained to evaluate the grainy/gritty texture. In particular, the grainy/gritty texture may be assessed by the panel by assessing the presence of grains within the food product upon visual inspection and/or tasting.

In a further embodiment, the shelf-stable plant-based fermented dairy drink analogue is a packaged shelf-stable plant-based fermented dairy drink analogue. Especially, the process comprises after step (f) (i.e. after the second heat treatment), a step of aseptically filling the shelf-stable plant-based fermented dairy drink analogue into a container, preferably a single serve container, more preferably a single serve carton container (e.g. Tetra Pak container), comprising an opening, which may be closed by a lid and/or a cap. The opening enables the consumption of the shelf-stable plant-based fermented dairy drink analogue by mouth drinking or by sucking up with a straw. The container may comprise a straw. Preferably, the container has a restricted headspace, especially the headspace represents at most 10%, at most 5% or at most 1% of the total volume of the container. As the shelf-stable plant-based fermented dairy drink analogue is homogeneous and stable over its shelf-life (i.e no separation of phase, sedimentation/settling and aggregation), the present invention overcomes the problems encountered in the art in relation with containers having a restricted headspace, especially single serve containers having a restricted headspace, more especially single serve carton containers having a restricted headspace. In particular, it overcomes the pre-cited problems of straw obstruction and unpleasant sensory experience.

In a second aspect, the invention relates to a shelf-stable plant-based fermented dairy drink analogue, preferably a shelf-stable plant-based drinkable yogurt analogue, obtained according to the process of the first aspect of the invention. The features of the shelf-stable plant-based fermented dairy drink analogue according to the third aspect of the invention listed herein below are applicable to the shelf-stable plant-based fermented dairy drink analogue according to this second aspect of the invention.

In a third aspect, the invention relates to a shelf-stable plant-based fermented dairy drink analogue.

Especially, the shelf-stable plant-based fermented dairy drink analogue is selected from the list consisting of shelf-stable plant-based fermented milk analogues, shelf-stable plant-based drinkable yogurt analogues, shelf-stable plant-based kefir dairy drink analogues and a combination thereof. More preferably, the shelf-stable plant-based fermented dairy drink analogue is a shelf-stable plant-based drinkable yogurt analogue.

The shelf-stable plant-based fermented dairy drink analogue is free from soy components and dairy components. More generally, the shelf-stable plant-based fermented dairy drink analogue is preferably free from any animal components.

The shelf-stable plant-based fermented dairy drink analogue comprises a hydrophilic liquid. Details about and examples of hydrophilic liquid are disclosed in the first aspect of the invention. The hydrophilic liquid contributes to improve the nutritional profile and/or the organoleptic profile of the shelf-stable plant-based fermented dairy drink analogue. In a further embodiment, the shelf-stable plant-based fermented dairy drink analogue comprises from 40 wt % to 95 wt %, preferably from 50 to 95 wt % or 60 to 95 wt % of hydrophilic liquid.

The shelf-stable plant-based fermented dairy drink analogue comprises a fermentable sugar. The fermentable sugar is converted into acid by the starter culture during the fermentation step. The acid formation will promote the formation of a gel with a sufficient consistency by the coagulation of plant proteins into a plant protein network. The consistency of the obtained gel can mimic the consistency of standard fermented dairy drinks, such as drinkable yogurts. Especially, after fermentation, the final product may exhibit a liquid or semi-liquid texture with enhanced viscosity and mouthfeel. Examples of fermentable sugar include agave syrup, brown sugar, coconut sugar, corn syrup, dextrose, fructose, glucose, honey, invert sugar, maltose, molasse, sucrose, sugar-containing liquid, sugar-containing cream, sugar-containing paste and mixtures thereof. In a preferred embodiment, the fermentable sugar is sucrose.

In a further embodiment, the shelf-stable plant-based fermented dairy drink analogue comprises from 1 wt % to 10 wt % of fermentable sugar. More preferably, the shelf-stable plant-based fermented dairy drink analogue comprises from 2 wt % to 10 wt % of fermentable sugar. More preferably, shelf-stable plant-based fermented dairy drink analogue comprises from 3 wt % to 10 wt % of fermentable sugar. Most preferably, the shelf-stable plant-based fermented dairy drink analogue comprises from 3 wt % to 8 wt % of fermentable sugar. Even most preferably, the shelf-stable plant-based fermented dairy drink analogue comprises from 3 wt % to 6 wt % of fermentable sugar. Such ranges guarantee an effective fermentation (i.e. low fermentation time to reach the targeted pH) and/or a good nutritional profile (i.e. not too high sugar content) at the same time.

The shelf-stable plant-based fermented dairy drink analogue comprises plant proteins. The plant proteins of the invention shall coagulate and form a gel upon acidification, especially upon fermentation. Indeed, the formation of a gel increases the viscosity of the final product and in the end, it enables to reach a range of textures that can mimic the textures of standard fermented dairy drink, such as drinkable yogurt. Especially, after fermentation, the final product may have a liquid or semi-liquid texture with enhanced viscosity and mouthfeel. Moreover, the final product has a liquid or semi-liquid texture that enables its consumption by mouth drinking and/or by sucking up with a straw or any other equivalent items.

The shelf-stable plant-based fermented dairy drink analogue has from 0.5 wt % to 3.4 wt % of plant protein, preferably from 1.5 wt % to 3.4 wt % or from 1.5 wt % to 3.0 wt % or from 1.5 wt. % to 2.6 wt %, more preferably from 1.9 wt % to 3.4 wt % or from 1.9 wt % to 3.0 wt %, most preferably from 1.9 wt % to 2.6 wt %. Without wishing to be bound by theory, these ranges of amount of plant proteins enables to reach a satisfactory texture upon acid gelation of plant proteins while minimizing protein precipitation. Above these ranges, the texture may not be suitable for drinking. In addition, these ranges of amount of plant protein, especially upper ranges, ensures an acceptable level of proteins for nutritional purposes.

In particular, the shelf-stable plant-based fermented dairy drink analogue comprises 0.5 wt %, 0.6 wt %, 0.7 wt %, 0.8 wt %, 0.9 wt %, 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, 2.1 wt %, 2.2 wt %, 2.3 wt %, 2.4 wt %, 2.5 wt %, 2. 6wt %, 2.7 wt %, 2.8 wt %, 2.9 wt %, 3.0 wt %, 3.1 wt %, 3.2 wt %, 3.3 wt %, 3.4 wt % of plant proteins.

In a preferred embodiment, the plant proteins are pulse proteins. The advantages of using pulse proteins are presented in the first aspect of the present invention. Preferably the pulse proteins are selected from the group consisting of bean proteins, chickpea proteins, fava bean proteins, lentil proteins, pea proteins, and mixtures thereof. Preferably, the pulse proteins are selected from the group consisting of fava bean proteins, pea proteins and a combination thereof. The advantages of using pea proteins and fava bean proteins are provided in the first aspect of the present invention.

In a more preferred embodiment, the pulse proteins are pea proteins. The advantages of using pea proteins are presented in the first aspect of the present invention.

In a preferred embodiment, the shelf-stable plant-based fermented dairy drink analogue comprises a total protein content of at most 3.4 wt %, preferably of at most 3.0 wt %, preferably of at most 2.6. Minimizing the protein content enables to limit, in a certain extent, the aggregation of proteins upon heat-treatment. This participates to achieve a plant-based fermented dairy drink analogue which is smooth in mouth and which does not exhibit an unpleasant sandy, grainy and/or gritty texture.

The shelf-stable plant-based fermented dairy drink analogue has a pH of 3.0 to 5.0, preferably of 3.5 to 4.5. This pH results from the fermentation of the fermentable sugars and possible other fermentable compounds by the starter culture(s).

The shelf-stable plant-based fermented dairy drink analogue has a shelf-life of at least 1 month, of at least 3 months, preferably at least 6 months, more preferably at least 9 months, most preferably at least 12 months at a temperature of 20° C. to 40° C., preferably of 20° C. to 37° C., more preferably of 20° C. to 35° C. and even more preferably of 20° C. to 30° C.

In another embodiment, the shelf-stable plant-based fermented dairy drink analogue has a shelf-life of 1 month, 2 months, 3 months, 6 months, 9 months or 12 months at a temperature of 20° C. to 40° C., preferably of 20° C. to 37° C., more preferably of 20° C. to 35° C. or even more preferably of 20° C. to 30° C. In another embodiment, the shelf-stable plant-based fermented dairy drink analogue has a shelf-life of at least 1 month, preferably of at least 3 months at a temperature of 20° C. to 40° C., preferably of 20° C. to 37° C., more preferably of 20° C. to 35° C., even more preferably of 20° C. to 30° C. and at a relative humidity of 60% to 75%. In another embodiment, the shelf-stable plant-based fermented dairy drink analogue has a shelf-life of at least 6 months, 9 months or 12 months, at a temperature of 20° C. to 40° C., preferably of 20° C. to 37° C., more preferably of 20° C. to 35° C., even more preferably of 20° C. to 30° C. and at a relative humidity of 60% to 75%. The relative humidity may be measured with a hygrometer, for example a psychometrer or a wet-and-dry-bulb thermometer.

In another embodiment, the shelf-stable plant-based fermented dairy drink analogue has a texture (i.e. viscosity) that enables its consumption by mouth drinking and/or by sucking up with a straw or any other equivalent items. Preferably, it has a texture (i.e. viscosity) that can mimic the texture of standard fermented dairy drinks, such as drinkable yogurts.

Especially, in an embodiment, the shelf-stable plant-based fermented dairy drink analogue has a viscosity of at least 50 mPa·s at 100 s⁻¹ at 10° C., preferably of at least 60 mPa·s at 100 s⁻¹ at 10° C. or of at least 70 mPa·s at 100 s⁻¹ at 10° C. More preferably, the shelf-stable plant-based fermented dairy drink analogue has a viscosity of at least 80 mPa·s at 100 s⁻¹ at 10° C. or of at least 90 mPa·s at 100 s⁻¹ at 10° C. Most preferably, the shelf-stable plant-based fermented dairy drink analogue has a viscosity of at least 100 mPa·s at 100 s⁻¹ at 10° C. Especially, the shelf-stable plant-based fermented dairy drink analogue has a viscosity ranging from 50 mPa·s to 390 mPa·s at 100 s⁻¹ at 10° C., preferably from 50 mPa·s to 350 mPa·s, from 60 mPa·s to 350 mPa·s, from 70 mPa·s to 390 mPa·s, from 80 mPa·s to 350 mPa·s or from 90 mPa·s to 350 mPa·s at 100 s⁻¹ at 10° C. More preferably, the shelf-stable plant-based fermented dairy drink analogue has a viscosity ranging from from 90 mPa·s to 300 mPa·s, preferably from 90 mPa·s to 200 mPa·s at 100 s⁻¹ at 10° C.

The viscosity is measured at 7 days after fermentation on samples of the shelf-stable plant-based fermented dairy drink analogue. First, the sample of the shelf-stable plant-based fermented dairy drink analogue is stored at a temperature of 10° C. for a minimum of 2 hours prior to measurement. Then, the sample is gently stirred in a circular motion 3 times before transferring to a Rheometer Haake RS600 (ThermoFisher Scientific, Waltham, Massachusetts, United-States) with plate/plate geometry (60 mm diameter), especially plate/plate geometry PP60, and with 1 mm gap. Flow curves with controlled shear rate ramp from 0 to 300 s⁻¹ (linear increase) may be obtained at 10° C.+/−0.1. Viscosity is measured using Rheowin software

(ThermoFisher Scientific, Waltham, Massachusetts, United-States) in terms of Pa*s at 100 s⁻¹ at 10° C.

In a preferred embodiment, the shelf-stable plant-based fermented dairy drink analogue is substantially free from, preferably entirely free from, any added thickening agents, except pectin, preferably high methoxyl pectin. Examples of added thickening agents include acacia gum, agar, alginate, carrageenan, gelatin, gellan, locust bean gum, starch, xanthan gum, and mixtures thereof. In the present context, the term “starch” includes ingredients consisting only of starch but also includes tapioca flours and corn flours. Despite the second heat treatment, the shelf-stable plant-based fermented dairy drink analogue has a satisfactory smooth and thick texture and no protein aggregation or any other destabilisation phenomena are observed, even when pectin, especially high methoxyl pectin, is used alone without any other added thickening agents.

In a further embodiment, the shelf-stable plant-based fermented dairy drink analogue comprises from 0.05 wt % to 1.0 wt % of pectin, preferably high methoxyl pectin. Preferably, the shelf-stable plant-based fermented dairy drink analogue comprises 0.1 wt % to 1.0 wt % or from 0.5 wt % to 1.0 wt % of pectin, preferably high methoxyl pectin.

In a preferred embodiment, the pectin is citrus high methoxyl pectin.

The interests of using pectin are explained in the first aspect of the present invention.

In another embodiment, the shelf-stable plant-based fermented dairy drink analogue may further comprise algae flours, antioxidants, cocoa, colours, edible plant oil, fibres, flavours, flower essence, fruits, fruit preparation, minerals, prebiotics, sauce, solid inclusions, spices, sweeteners, tea, vegetables and/or vitamins. Preferably, the shelf-stable plant-based fermented dairy drink comprises a fruit preparation, preferably a fruit puree, more preferably a banana puree. In a preferred embodiment, the shelf-stable plant-based fermented dairy drink comprises 5-50 wt %, preferably 10-40 wt %, more preferably 15-30 wt %, most preferably 15-26 wt fruit preparation. Preferably, the fruit preparation is a fruit puree, more preferably a banana puree.

In a particular embodiment, the fruit puree, more preferably the banana puree, has from 10° to 30° Brix, preferably from 20° to 30° Brix, more preferably from 22° to 26° Brix.

In another embodiment, the shelf-stable plant-based fermented dairy drink analogue may further comprise a food-grade acidic compound, preferably lactic acid.

In an additional embodiment, the shelf-stable plant-based fermented dairy drink analogue has a dry matter from 6 wt % to 20wt %, preferably from 8 wt % to 20 wt %. More preferably, the dry matter is from 8 wt % to 15 wt %. Most preferably, the dry matter is from 11 wt % to 13 wt %. The dry matter, including the protein content, participates in the texture of the final food product.

In a preferred embodiment, the shelf-stable plant-based fermented dairy drink analogue does not have a grainy or gritty texture. By “grainy or gritty texture”, it means a texture characterized by grains discernible in mouth upon tasting and/or discernible upon visual inspection. The grainy/gritty texture of a food product, including drinks, may be assessed by a panel which has been trained to evaluate the grainy/gritty texture. In particular, the grainy/gritty texture may be assessed by the panel by assessing the presence of grains within the food product upon visual inspection and/or tasting.

In a particular embodiment, the shelf-stable plant-based fermented dairy drink analogue is packaged into a container, preferably a single serve container, more preferably a single serve carton container (e.g. Tetra Pak container), comprising an opening, which may be closed by a lid and/or a cap. The opening enables the consumption of the shelf-stable plant-based fermented dairy drink analogue by mouth drinking or by sucking up with a straw. The container may comprise a straw. The container comprising the shelf-stable plant-based fermented dairy drink analogue has a restricted headspace, especially the headspace represents at most 10%, at most 5% or at most 1% of the total volume of the container. As the shelf-stable plant-based fermented dairy drink analogue is homogeneous and stable over its shelf-life (i.e no separation of phase, sedimentation/settling and aggregation), the present invention overcomes the problems encountered in the art in relation with containers having a restricted headspace, especially single serve containers having a restricted headspace, more especially single serve carton containers having a restricted headspace. In particular, it overcomes the pre-cited problems of straw obstruction and unpleasant sensory experience.

The shelf-stable plant-based fermented dairy drink analogue of the invention entails numerous advantages. A shelf-stable plant-based fermented dairy drink analogue product is provided, such a plant-based fermented dairy drink analogue being free from dairy components and soy components, and being shelf-stable. Said shelf-stable plant-based fermented dairy drink analogue is convenient and may be safely taken away or stored in shelves without the need of a cold storage at a temperature between 1° C. and 10° C. In addition, said shelf-stable plant-based fermented dairy drink analogue is homogeneous, has a thick and smooth texture and has preferably limited off-notes. Especially, the food product does not exhibit any plant protein aggregation, any separation of phases or settling, even in the presence of pectin alone, despite its shelf-life of several months. In addition, the plant protein aggregation is limited, even in the presence of a significant content of protein for nutritional purpose. Moreover, the shelf-stable plant-based fermented dairy drink analogue product has a satisfactory texture that can mimic the texture of standard fermented dairy drinks, such as drinkable yogurts.

In a fourth aspect, the invention may relate to a food product which comprises a shelf-stable plant-based fermented dairy drink analogue according to the second aspect or the third aspect of the invention.

In a particular preferred embodiment, the food product comprises the shelf-stable plant-based fermented dairy drink analogue as an ingredient of its recipe. It is preferred that the food product preparation involves a step of mixing the shelf-stable plant-based fermented dairy drink analogue with the other component of the food product. The amount of the shelf-stable plant-based fermented dairy drink analogue in the food product will vary upon on the type of food product, the desired texture, the desired taste and the desired nutritional profile. Examples of food products according to the third aspect of the invention include batters, bites, cakes, doughs, drinks, ready-to-drinks, juices, sauces, smoothies, soups and spreads.

In another embodiment, the food product is a multilayer food product and comprises one or several layers of shelf-stable plant-based fermented dairy drink analogue. The food product may comprise layers that consist of layers of fruit preparation, honey, sauce, solid pieces, vegetable preparation, whipped cream and mixtures thereof.

Those skilled in the art will understand that they can freely combine all features of the present invention disclosed herein. Further, features described for different embodiments of the present invention may be combined.

Furthermore, where known equivalents exist to specific features, such equivalents are incorporated as if specifically referred in this specification. Further advantages and features of the present invention are apparent from the figures and non-limiting examples.

### EXAMPLES

### Example 1: Recipes and Processes for Preparing the Different Shelf-Stable Plant-Based Fermented Dairy Drink Analogue Variants

### Recipes of the Different Shelf-Stable Plant-Based Fermented Dairy Drink Analogue Variants

Eight different shelf-stable plant-based fermented dairy drink analogue variants were prepared. The recipes of the eight plant-based yogurt analogue variants are disclosed in Table 1A and Table 1B.

TABLE 1A

| | Variant 1 | | Variant 2 | | Variant 3 | | Variant 4 | | Variant 5 | |
|---|---|---|---|---|---|---|---|---|---|---|
| | DSI High- | | DSI Low- | | DSI High- | | DSI Low- | | DSI High- | |
| | pectin- | | pectin- | | pectin- | | pectin- | | pectin- | |
| | AFTER | | AFTER | | BEFORE | | BEFORE | | BEFORE | |
| Ingredients | ferm | | ferm | | ferm | | ferm | | homo | |
| Water | 70.84 | wt % | 70.84 | wt % | 70.84 | wt % | 70.84 | wt % | 70.84 | wt % |
| Coconut cream, | 2.42 | wt % | 2.42 | wt % | 2.42 | wt % | 2.42 | wt % | 2.42 | wt % |
| 24% fat | | | | | | | | | | |
| White sugar | 3.60 | wt % | 3.60 | wt % | 3.60 | wt % | 3.60 | wt % | 3.60 | wt % |
| Pea protein | 2.42 | wt % | 2.42 | wt % | 2.42 | wt % | 2.42 | wt % | 2.42 | wt % |
| isolate, 80% | | | | | | | | | | |
| protein | | | | | | | | | | |
| Concentrated | 0.70 | wt % | 0.70 | wt % | 0.70 | wt % | 0.70 | wt % | 0.70 | wt % |
| high methoxyl | | | | | | | | | | |
| pectin solution, | | | | | | | | | | |
| with 5.5% | | | | | | | | | | |
| pectin * | | | | | | | | | | |
| Banana puree | 20.00 | wt % | 20.00 | wt % | 20.00 | wt % | 20.00 | wt % | 20.00 | wt % |
| Starter culture | 0.02 | wt % | 0.02 | wt % | 0.02 | wt % | 0.02 | wt % | 0.02 | wt % |
| Total input | 100 | wt % | 100 | wt % | 100 | wt % | 100 | wt % | 100 | wt % |
| ingredients | | | | | | | | | | |

* NB: The concentrated high methoxyl pectin solution is obtained by hydrating pectin into water at 70° C. until dissolution to reach a content of 5.5 wt %. The temperature of the concentrated high methoxyl pectin solution is maintained at 70° C. before its addition into the analogue being manufactured.

TABLE 1B

| | Variant 6 | | |
|---|---|---|---|
| | DSI Low- | | |
| | pectin- | Variant 7 | Variant 8 |
| | AFTER | DSI High- | DSI Low- |
| Ingredients | ferm | no pectin | no pectin |

| Water | 70.84 | wt % | 71.44 | wt % | 71.44 | wt % |
|---|---|---|---|---|---|---|
| Coconut cream, | 2.42 | wt % | 2.52 | wt % | 2.52 | wt % |
| 24% fat | | | | | | |
| White sugar | 3.60 | wt % | 3.60 | wt % | 3.60 | wt % |
| Pea protein | 2.42 | wt % | 2.42 | wt % | 2.42 | wt % |
| isolate, 80% | | | | | | |
| protein | | | | | | |
| Concentrated | 0.70 | wt % | — | | — | |
| high methoxyl | | | | | | |
| pectin solution | | | | | | |
| with 5.5% pectin* | | | | | | |
| Banana puree | 20.00 | wt % | 20.00 | wt % | 20.00 | wt % |
| Starter culture | 0.02 | wt % | 0.02 | wt % | 0.02 | wt % |
| Total input | 100 | wt % | 100 | wt % | 100 | wt % |
| ingredients | | | | | | |

*NB: The concentrated high methoxyl pectin solution is obtained by hydrating pectin into water at 70° C. until dissolution to reach a content of 5.5 wt %. The temperature of the concentrated high methoxyl pectin solution is maintained at 70° C. before its addition into the analogue being manufactured.

The variants with pectin, especially variants 1-6, have a total protein content of 2.06 wt % and a total fat content of 0.98% and a dry matter of 11.85%

The variants without pectin, especially variants 7-8, also have a total protein content of 2.06 wt % and a total fat content of 0.98% and a dry matter of 11.22%.

### Process for Preparing the Different Variants of Shelf-Stable Plant-Based Fermented Dairy Drink Analogues

The shelf-stable plant-based fermented dairy drink analogue without pectin, that-is-to-say variants 7 and 8 were prepared as follows. The plant proteins were hydrated for 20 minutes at 55° C. A plant-based food composition was prepared by mixing the hydrated proteins, the coconut cream and the white sugar. The plant-based food composition is pre-heated to 60° C. and is then homogenized at 250 bars at 60° C. The homogenized plant-based food composition is then heat-treated at 92° C. for 360 seconds. The homogenized and heat-treated plant-based food composition is inoculated with 0.02% of a starter culture comprising a Lactobacillus delbrueckii subsp. bulgaricus strain and a Streptococcus thermophilus strain. After inoculation, the inoculated plant-based food composition is fermented at 43° C. until reaching a pH of 4.6 to obtain a plant-based yogurt analogue. The plant-based yogurt analogue is then smoothed in a Ytron equipment with a rotation speed of 30 Hz and stored overnight at 4° C. to obtain a chilled plant-based fermented dairy drink analogue. The chilled plant-based fermented dairy drink analogue is mixed with a banana puree at 4° C. Thereafter, a solution comprising 80% lactic acid is added to the chilled plant-based fermented dairy drink analogue to reach a pH of 4.45. Subsequently, for variant 7 (DSI high), the plant-based fermented dairy drink analogue is then heat treated by direct steam injection at 120° C. for 3 seconds to obtain a shelf-stable plant-based fermented dairy drink analogue (i.e. variant 7). For variant 8 (DSI low), the plant-based fermented dairy drink analogue is heat treated by direct steam injection at 85° C. for 30 seconds to obtain a shelf-stable plant-based fermented dairy drink analogue (i.e. variant 8). The shelf-stable plant-based fermented dairy drink analogues were aseptically dosed into single serve containers and the containers were stored at ambient temperature (i.e. room temperature or 37° C.).

The variants qualified as “DSI high”, especially variants 1, 3, 5 and 7, underwent a second heat treatment by direct steam injection at a temperature of 120° C. for 3 seconds to obtain a shelf-stable plant-based fermented dairy drink analogue

The variants qualified as “DSI low”, especially variants 2, 4, 6 and 8, underwent a second heat treatment by direct steam injection at a temperature of 85° C. for 30 seconds to obtain a shelf-stable plant-based fermented dairy drink analogue.

For variants qualified as “pectin-before homo”, especially variants 1 and 2, have substantially the same process as the process for variants 7 and 8. The only difference is that the pectin, especially the concentrated high methoxyl pectin solution, was added before the homogenization step, especially after the step where the hydrated proteins, the coconut cream and the white sugar are mixed together.

For variants qualified as “pectin-before Ferm”, especially variants 3 and 4, have substantially the same process as the process for variants 7 and 8. The only difference is that the pectin, especially the concentrated high methoxyl pectin solution, was added before the fermentation step, especially just before the inoculations step.

For variants qualified as “pectin-after Ferm”, especially variants 5 and 6, the pectin have substantially the same process as the process for variants 7 and 8. The only difference is that the pectin, especially the concentrated high methoxyl pectin solution, was added after the fermentation step, especially just before the smoothing step which is upstream to the second heat-treatment.

### Example 2: Visual and Sensory Evaluation of the Shelf-Stable Plant-Based Fermented Dairy Drink Analogues After a Storage of 7 Days at Ambient Temperature

### Method:

The appearance of the different shelf-stable plant-based fermented dairy drink analogues was assessed by visual evaluation, after 7 days of storage at room temperature (between 21° C. and 26° C.). Moreover, the different shelf-stable plant-based fermented dairy drink analogues were also tasted to assess the sensory profile (i.e. taste and texture).

### Results:

Compared to variants with pectin (i.e. variants 1-6), the variants without pectin (i.e. variants 7-8) appeared more sandy, more liquid and much more acidic, whatever the intensity of the second heat-treatment (DSI high or DSI low). These features, especially sandiness, show that variants 7-8 without pectin are not stable after undergoing the second heat-treatment.

Hence, the addition of pectin enables to improve the stability of the shelf-stable plant-based fermented dairy drink analogues. In addition, the pectin seems to avoid deviations in terms of taste, especially excessive acidity.

### Example 3: Visual Evaluation of the Stability of the Shelf-Stable Plant-Based Fermented Dairy Drink Analogues After a Storage of 1 Month at Ambient Temperature

### Method:

The stability of the different shelf-stable plant-based fermented dairy drink analogues was assessed by visual evaluation, after a storage of 1 month at room temperature (i.e. between 21° C.-26° C.) and after a storage of 1 month at 37° C. The assessment of stability at a storage of 37° C. is called an “accelerated” storage test and is intended to give an idea on the behaviour of the product for longer storage, especially for storage of higher than 1 month.

Especially, 3 parameters were assessed by visual evaluation:
Sediment formation: settling of particles at the bottom of the package containing the shelf-stable plant-based fermented dairy drink analogue.
Serum formation: formation of serum, by syneresis or subsequent to sedimentation/creaming, within the shelf-stable plant-based fermented dairy drink analogue.
Heterogeneity: shelf-stable plant-based fermented dairy drink analogues with several phases due to separation of phases.

The sediment formation and serum formation were assessed by giving a score ranging from 0 to 10. For serum formation, a score 0 corresponds to the absence of sediment formation and a score 5 corresponds to the high presence of sediment formation. For serum formation, a score 0 corresponds to the absence of serum formation and a score 5 corresponds to the high presence of serum formation.

The heterogeneity was assessed qualitatively by determining the presence of different phases (yes) or the absence of different phases (no).

A low stability would be translated by a high sediment formation score, a high serum formation score and the presence of different phases (yes).

### Results:

The results are displayed in Table 2. Whatever the variant, there is no or a very low sediment formation (scores between 0 and 1). However, for variants without pectin (i.e. variants 7-8) contrary to the ones with pectin (i.e. variants 1-6), it is observed a high formation of serum (maximum score of 5) and the products exhibit a heterogeneous structure with several phases, whatever the temperature of the second heat-treatment (DSI high or DSI low).

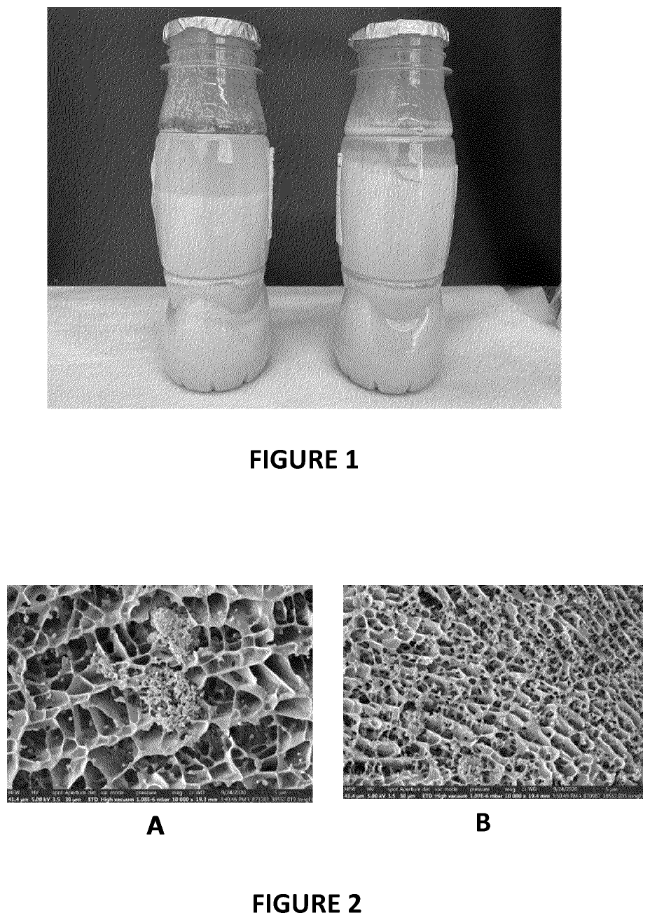

In addition, FIG. 1 shows the heterogeneous structure with different phases of variants 7 and 8 stored for two months at room temperature. This heterogeneous structure is even more pronounced when the fermented dairy drink analogues have undergone a high-temperature second heat treatment (i.e. DSI high) (FIG. 1).

Hence, the addition of pectin, especially high methoxyl pectin, enables to improve the stability of the product over the shelf life at ambient temperature. Especially, pectin enables to minimize serum formation and avoids the appearance of a heterogeneous structure due to separation of phases.

TABLE 2

| | Sediment | | Serum | | | |
|---|---|---|---|---|---|---|
| | formation | | formation | | | |
| | (storage 1 | | (storage 1 | | Structure | |
| | month at | Sediment | month at | Serum | (storage 1 | |
| | room | formation | room | formation | month at room | |
| | temperature | (storage 1 | temperature | (storage 1 | temperature | Homogeneity |
| | (i.e. 21° C.- | month at | (i.e. 21° C.- | month at | (i.e. 21° C.- | (storage 1 |
| Variants | 26° C.)) | 37° C.) | 26° C.)) | 37° C.) | 26° C.)) | month at 37° C.) |
| Variant 1 | 0 | 0 | 0 | 1 | no | no |
| DSI High- pectin- | | | | | | |
| AFTER ferm | | | | | | |
| Variant 2 | 0 | 0 | 0 | 1 | no | no |
| DSI Low- pectin- | | | | | | |
| AFTER ferm | | | | | | |
| Variant 3 | 0 | 0 | 0 | 1 | no | no |
| DSI High- pectin- | | | | | | |
| BEFORE ferm | | | | | | |
| Variant 4 | 0 | 0 | 0 | 1 | no | no |
| DSI Low- pectin- | | | | | | |
| BEFORE ferm | | | | | | |
| Variant 5 | 0 | 1 | 1 | 2 | no | no |
| DSI High- pectin- | | | | | | |
| BEFORE homo | | | | | | |
| Variant 6 | 0 | 0 | 1 | 1 | no | no |
| DSI Low- pectin- | | | | | | |
| BEFORE homo | | | | | | |
| Variant 7 | 1 | 1 | 5 | 5 | yes | yes |
| DSI High- pectin- | | | | | | |
| BEFORE homo | | | | | | |
| Variant 8 | 0 | 0 | 5 | 5 | yes | yes |
| DSI Low- pectin- | | | | | | |
| BEFORE homo | | | | | | |

### Example 4: Assessment of the Viscosity of the Shelf-Stable Plant-Based Fermented Dairy Drink Analogues After a Storage of 7 Days at Ambient Temperature

### Method:

The viscosity of the different shelf-stable plant-based fermented dairy drink analogues was assessed after 7 days of storage at room temperature (between 21° C. and 26° C.).

The viscosity was assessed as follows. First, the samples of the shelf-stable plant-based fermented dairy drink analogues were stored at a temperature of 10° C. for a minimum of 2 hours prior to measurement. Then, the samples were gently stirred in a circular motion 3 times before transferring to a Rheometer Haake RS600 (ThermoFisher Scientific, Waltham, Massachusetts, United-States) with plate/plate geometry (60 mm diameter), especially plate/plate geometry PP60, and with 1 mm gap. Flow curves with controlled shear rate ramp from 0 to 300 s⁻¹ (linear increase) may be obtained at 10° C.+/−0.1. Especially, the viscosity is measured using Rheowin software (ThermoFisher Scientific, Waltham, Massachusetts, United-States) in terms of Pa*s at 100 s⁻¹ at 10° C.

### Results:

The results are displayed in table 3.

The lowest viscosities, below 40 mPa·s, were obtained for the variants without pectin (ie. variants 7-8). This viscosity is unsatisfactory with the present recipe.

The addition of pectin enables to significantly compensate this low viscosity with the obtaining of viscosities over 90mPa·s for variants 1-4. Highest textures are obtained, especially textures that potentially mimic the texture of fermented dairy drinks having a thickened texture.

However, when the pectin is added before homogenization, the viscosity is unsatisfactory, with values below 65mPa·s. Hence, it appears that the addition of pectin before homogenization prevents from getting optimal viscosities.

More generally, it is observed that lower viscosities were obtained for variants that have undergone a “low intensity” second heat treatment (i.e. DSI low) compared to variants that have undergone a “low intensity” second heat treatment (i.e. DSI high). However, as shown in table 3, despite this viscosity loss, the viscosity remains satisfactory for variants where pectin is added after homogenization (i.e variants 1-4).

Hence, it appears crucial to add the pectin downstream to the homogenization step. It enables to achieve products having optimal viscosities and potentially enhanced mouthfeel. The addition of pectin before homogenization is not advantageous as it prevents from achieving optimal texture with substantially high viscosities. Especially, the mimicry of the texture of fermented dairy drinks having thickened textures may become hardly achievable when the pectin is added before homogenization.

TABLE 3

| | Viscosity at 10° C., 100 s⁻¹ |
|---|---|
| Variants | (mPa · s) |
| Variant 1 | 91 |
| DSI High- pectin- AFTER ferm | |
| Variant 2 | 103 |
| DSI Low- pectin- AFTER ferm | |
| Variant 3 | 95 |
| DSI High- pectin- BEFORE ferm | |
| Variant 4 | 107 |
| DSI Low- pectin- BEFORE ferm | |
| Variant 5 | 52 |
| DSI High-pectin-BEFORE homo | |
| Variant 6 | 61 |
| DSI Low- pectin- BEFORE homo | |
| Variant 7 | 23 |
| DSI High- no pectin | |
| Variant 8 | 38 |
| DSI Low- no pectin | |

### Example 5: Assessment of the Microstructure of the Shelf-Stable Plant-Based Fermented Dairy Drink Analogues Depending on the Point of Addition of the Pectin

### Method:

Confocal laser scanning microscopy and cryo scanning electron microscopy analyses were conducted for variant 1 (DSI High-pectin-AFTER ferm) and variant 5 (DSI High-pectin-BEFORE homo) to assess the impact of the addition of before or after homogenisation on the microstructure of the shelf-stable plant-based fermented dairy drink analogues.

The images were performed on analogues after 2 month storage at room temperature.

### Confocal Laser Scanning Microscopy:

The samples of variant 1 and variant 5 were colored with Nile Red (Red) 10 μ/ml samples to tag lipids and Fast green (Green) 10 μ/ml samples to tag proteins.

The samples were analyzed with a confocal laser scanning microscope LSM 710 equipped with a detector Airyscan (Carl Zeiss, Oberkochen, Allemagne).

Protein imaging was conducted at an excitation lengthwave of 633 nm and lipid imaging was conducted at an excitation lengthwave of 488 nm.

### Cryo Scanning Electron Microscopy

The Samples of variant 1 and variant 5 were prepared by pouring 5-10 μL of each variant into rivets and poured into nitrogen slush at −207° C. and were then fractured at −140° C.

Water was allowed to sublimate by heating the sample to −90° C. for 3 minutes (fast etching) and 30 minutes (slow etching) in order to reveal different substructures.

Samples were then coated with Pt before being observed with a Quattro S SEM (ThermoFischer).

### Results:

On the cryo scanning electron microscopy images (FIG. 2), it seems that the mesh of the network formed is larger for variant 5 (FIG. 2A) than for variant 1 (FIG. 2B) indicating that the distribution of the ingredients does not have same effect on ice crystallization.

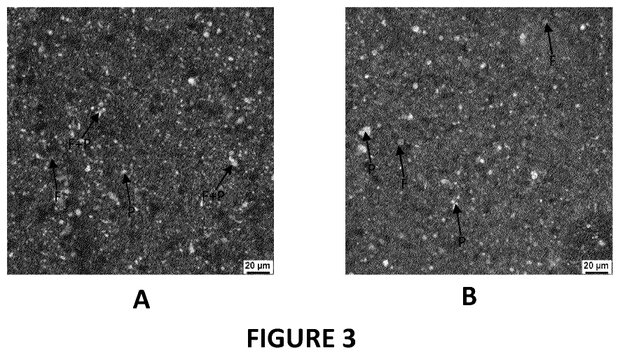

For confocal laser scanning microscopy imaging (FIG. 3), it seems that in variant 5 (FIG. 3A), there is more overlap between the fat and protein signals leading to yellow color while for variant 1 (FIG. 3B) fat signal appears almost always in red. This would mean that in variant 5 fat is more intricated with protein network than variant 1. Moreover, the fat looks more homogenously distributed in the protein structure for variant 1 (FIG. 3B) rather than for variant 5 (FIG. 3A). Regarding the protein signal, it seems variant 5 (FIG. 3A), has a denser protein structure, rather coarse with some large aggregated regions closely packed, while for variant 1 (FIG. 3B), proteins seem to be less densely packed and more homogenously distributed in somewhat smaller aggregates.

Hence, the addition of pectin upstream or downstream homogenization seems to have an impact of the microstructure of the obtained shelf-stable plant-based fermented dairy drink analogues. This difference in microstructure might explain differences in terms of macrostructure such as texture and stability.

### Example 6: Recipe and Process for Preparing With Faba Bean Proteins

Table 4 provides a recipe of a shelf-stable plant-based fermented dairy drink analogue prepared with faba bean protein concentrate.

TABLE 4

| | Shelf-stable plant-based fermented | |
|---|---|---|
| | dairy drink analogue prepared with | |
| Ingredients | faba bean protein concentrate | |
| Water | 69.80 | wt % |
| Coconut cream, 24% fat | 2.52 | wt % |
| White sugar | 3.60 | wt % |
| Faba bean protein concentrate, 60% | 3.56 | wt % |
| protein | | |
| Concentrated high methoxyl pectin | 0.41 | wt % |
| solution with 5.5% pectin | | |
| Banana puree | 20.00 | wt % |
| Banana flavour | 0.09 | wt % |
| Starter culture | 0.02 | wt % |
| Total input ingredients | 100 | wt % |

The concentrated high methoxyl pectin solution is prepared as described in example 1 (cf. tables 1A and 1B)

The faba bean proteins were hydrated for 20 minutes at 55° C. A plant-based food composition was prepared by mixing the hydrated faba bean proteins, the coconut cream and the white sugar. The plant-based food composition is pre-heated to 60° C. and is then homogenized at 250 bars at 60° C. The homogenized plant-based food composition is then heat-treated at 92° C. for 360 seconds. The homogenized and heat-treated plant-based food composition is inoculated with 0.02% of a starter culture comprising a Lactobacillus delbrueckii subsp. bulgaricus strain, a Streptococcus thermophilus strain, a Lactobacillus acidophilus strain, a Lactobacillus paracasei strain and a Bifidobacterium species strain. After inoculation, the inoculated plant-based food composition is fermented at 43° C. until reaching a pH of 4.6 to obtain a plant-based yogurt analogue. The concentrated high methoxyl pectin solution is subsequently added to the plant-based yogurt analogue. The plant-based yogurt analogue is then smoothed in a Ytron equipment with a rotation speed of 30 Hz and stored overnight at 4° C. to obtain a chilled plant-based fermented dairy drink analogue. The chilled plant-based fermented dairy drink analogue is mixed with a banana puree and banana flavour at 4° C. Thereafter, the plant-based fermented dairy drink analogue is then heat treated by direct steam injection at 85° C. for 30 seconds or at 120° C. for 3 seconds to obtain a shelf-stable plant-based fermented dairy drink analogue. The shelf-stable plant-based yogurt analogue is then aseptically dosed into a single serve container and the package is stored at ambient temperature (e.g. room temperature).

### Example 7: Evolution of the Stability, Taste and Texture of Shelf-Stable Plant-Based Fermented Dairy Drink Analogues Over the Shelflife

### Recipes of the Different Shelf-Stable Plant-Based Fermented Dairy Drink Analogue Variants

Two different shelf-stable plant-based fermented dairy drink analogue variants according to the invention were prepared: variant A prepared with pea proteins and variant B prepared with faba bean proteins. The recipes of the two plant-based fermented dairy drink analogue variants A and B are disclosed in Table 5.

TABLE 5

| | | |
|---|---|---|
| Ingredients | Variant A | Variant B |

| | | | | |
|---|---|---|---|---|
| Water | 70.94 | wt % | 69.80 | wt % |
| Coconut cream, 24% fat | 2.52 | wt % | 2.52 | wt % |
| White sugar | 3.60 | wt % | 3.60 | wt % |

| | | | |
|---|---|---|---|
| Pea protein isolate, 80% protein | 2.42 | wt % | — |

| | | |
|---|---|---|
| Faba bean protein concentrate, | — | 3.56 |

| | | | | |
|---|---|---|---|---|
| 60% protein | | | | |
| Concentrated high methoxyl | 0.50 | wt % | 0.50 | wt % |
| pectin solution, with | | | | |
| 5.5% pectin * | | | | |
| Banana puree | 20.00 | wt % | 20.00 | wt % |
| Starter culture | 0.02 | wt % | 0.02 | wt % |
| Total input ingredients | 100 | wt % | 100 | wt % |

### Preparation of the Different Shelf-Stable Plant-Based Fermented Dairy Drink Analogue Variants

The shelf-stable plant-based fermented dairy drink analogue variants A and B were prepared as follows. The plant proteins (pea proteins for variant A, faba bean proteins for variant B) were hydrated in RO water for 20 minutes at 55° C. A plant-based food composition was prepared by mixing for 20 minutes the hydrated proteins, the coconut cream and the white sugar (cf. table 5). The plant-based food composition is pre-heated to 60° C. and is then homogenized at 200 bars at 60° C. The homogenized plant-based food composition is then heat-treated at 92° C. for 60 seconds and cooled down to 43° C. The homogenized and heat-treated plant-based food composition is inoculated with 0.02% of a starter culture comprising a Lactobacillus delbrueckii subsp. bulgaricus strain and a Streptococcus thermophilus strain. After inoculation, the inoculated plant-based food composition is fermented at 43° C. until reaching a pH of 4.6 to obtain a plant-based yogurt analogue. A concentrated solution of pectin (cf. table 5) is then added to the plant-based yogurt analogue. The plant-based yogurt analogue is then smoothed in a Ytron equipment with a rotation speed of 30 Hz and stored overnight at 4° C. to obtain a chilled plant-based fermented dairy drink analogue. The chilled plant-based fermented dairy drink analogue is mixed with a banana puree at 4° C. Thereafter, a solution comprising 80% lactic acid is added to the chilled plant-based fermented dairy drink analogue to reach a pH of 4.45. Subsequently, the plant-based fermented dairy drink analogue is then heat treated by direct steam injection at 120° C. for 3 seconds to obtain a shelf-stable plant-based fermented dairy drink analogue. The shelf-stable plant-based fermented dairy drink analogues (variants A and B) were aseptically dosed into single serve containers such that the containers have a headspace of at most 10% and the containers were stored at ambient temperature (i.e., room temperature or 37° C.).

### Assessment of the Stability of Variants A and B Over the Shelf-Life

The stability of variants A and B was assessed at different time over the shelf-life (0, 1, 3, 5, 7, 9 11 storage after manufacturing) when stored at room temperature. The stability was assessed by evaluating two markers of destabilization: the creaming and the sedimentation.

The creaming is a marker of destabilization, in particular separation of phase, and corresponds to the accumulation of fat on the surface of the product and on the lid. Creaming is evaluated by pouring the variant A or B into a glass beaker. Creaming is evaluated based on the amount of fat deposit on the product surface and on the lid of the package. The creaming on the lid has to be determined within 2 minutes after opening. The creaming is scored from 0 (=no fat accumulated on the surface/lid) to 5 (=high amount of fat accumulated on the surface/lid).

The sedimentation is a marker of destabilization and corresponds to the accumulation of sediments at the bottom of the product. The sedimentation is evaluated at the bottom of the package after pouring the liquid into a glass beaker. The sediment height is judged by eye and/or with a ruler. The ruler is immersed upright into the sediment at the bottom of the package from the edge to the middle. The height of the wetted ruler is determined. The sedimentation is scored as follows:
0=no sediment visible on the bottom,
1=the bottom is covered near the wall (trace),
2=about 1 mm sediment measured with ruler-middle seal is still clearly visible,
3=about 2 mm sediment measured with ruler-middle seal is still clearly visible,
4=about 3 mm sediment measured with ruler,
5=above 4 mm sediment measured with ruler.
   The results are provided in Table 6 below.

TABLE 6

| | | 0 | 1 | 3 | 5 | 7 | 9 | 11 |
|---|---|---|---|---|---|---|---|---|
| | | Month | month | month | month | month | month | month |
| Variant | | storage | storage | storage | storage | storage | storage | storage |
| Variant | Creaming | 0 | 0 | 0 | 0 | 0 | 0 | 0 |
| A | Sedimentation | 0 | 0 | 0 | 0 | 0 | 0 | 0 |
| Variant | Creaming | 0 | 0 | 0 | 0 | 0 | 0 | 0 |
| B | Sedimentation | 0 | 0 | 0 | 0 | 0 | 0 | 1 |

Table 6 shows that both variants A and B exhibit limited level of destabilisation (i.e.

creaming & sedimentation) over the shelf-life at room temperature. In particular, no creaming is visible for variants A and B after 11 months of storage at room temperature after manufacturing. No sedimentation is visible for variant A after 11 months of storage at room temperature after manufacturing. No sedimentation is visible for variant B after 9 months storage at room temperature after manufacturing. Sedimentation appears after 11 months storage at room temperature after manufacturing with a score 1 but it remains very limited and acceptable (low score).

Hence, it can be concluded that the two different shelf-stable plant-based fermented dairy drink analogue variants according to the invention, i.e. variants A and B, appear stable over several months when stored at room temperature.

### Assessment of the Taste and Texture of Variants A and B Over the Shelf-Life

The taste and the texture of variants A and B stored were assessed upon tasting at different time over the shelf-life (i.e. 0, 1, 3, 5, 7, 9 and 11 months) by a panel. The variants A and B were stored at room temperature over the shelf-life. The panel is trained to evaluate the taste and the texture of shelf-stable plant-based fermented dairy drink analogues.

It results from the tasting that the taste and texture of variants A and B remain substantially acceptable over 11 months at room temperature.

On the taste side, no off-notes, no excessive acidity or any undesirable taste occur within variants A or B over 11 months when compared with the variants A or B obtained just after manufacturing (i.e. 0 month).

On the texture side, the texture remains viscous and smooth over the shelf-life. No grains are perceived in mouth and visually over 11 months for variant A and B, especially no gritty/grainy texture occurs over 11 months.

Hence, it can be concluded that the two different shelf-stable plant-based fermented dairy drink analogue variants according to the invention, i.e. variants A and B, have good stability. In particular, variants A and B have acceptable/good taste and texture over several months when stored at room temperature.

Although the invention has been described by way of example, it should be appreciated that variations and modifications may be made without departing from the scope of the invention as defined in the claims.

1. Process for preparing a shelf-stable plant-based fermented dairy drink analogue, which comprises the steps of:
(a) providing a plant-based food composition comprising a hydrophilic liquid, a fermentable sugar, and plant proteins, wherein said plant-based food composition comprises from 0.5 wt % to 3.4 wt % of plant proteins, wherein the plant-based food composition is free from soy and dairy components,
(b) homogenizing the plant-based food composition at a pressure above 50 bar,
(c) heat treating the plant-based food composition at a temperature from 80° C. to 100° C. for 1 minute to 10 minutes,
(d) inoculating the heat-treated and homogenized plant-based food composition with at least one starter culture to obtain an inoculated plant-based food composition,
(e) fermenting the inoculated plant-based food composition until reaching a pH from 3.0 to 5.0,
(f) heat-treating the plant-based fermented dairy drink analogue at a temperature from 75° C. to 125° C. for 3 seconds to 90 seconds to obtain a shelf-stable plant-based fermented dairy drink analogue, and
wherein the process comprises a step of addition of pectin into the plant-based food composition and/or the plant-based fermented dairy drink analogue after step (b) and before step (f).

2. Process according to claim 1, wherein the plant-based food composition comprises from 1 wt % to 10 wt % of fermentable sugar.

3. Process according to claim 1, wherein the plant proteins are pulse proteins.

4. Process according to claim 1, wherein the at least one starter culture comprises at least one lactic acid-producing bacteria.

5. Process according to claim 4, wherein the starter culture further comprises:
at least one yeast,
at least one acetic acid-producing bacteria.

6. Process according to claim 1, wherein the pectin is added such that plant-based food composition and/or the plant-based fermented dairy drink analogue comprises from 0.05 wt % to 1.0 wt % of pectin, preferably high methoxyl pectin.

7. Process according to claim 1, wherein the pectin is added between steps (c) and (d) or between steps (e) and (f).

8. Process according to claim 1, wherein the process does not comprise a step of addition of any added thickening agents.

9. Process according to claim 1, wherein the shelf-stable plant-based fermented dairy drink analogue has a shelf-life of at least 3 months at a temperature of 20° C. to 40° C.

10. Process according to claim 1, wherein the shelf-stable plant-based fermented dairy drink analogue has a viscosity of at least 50 mPa·s at 100 s⁻¹ at 10° C. measured by means of a rheometer with plate-plate geometry (60 mm diameter) and with 1 mm gap.

11. A shelf-stable plant-based fermented dairy drink analogue obtained by the process of claim 1.

12. A shelf-stable plant-based fermented dairy drink analogue, wherein said shelf-stable plant-based fermented dairy drink analogue is free from soy and dairy components and said shelf-stable plant-based fermented dairy drink analogue comprises:
a hydrophilic liquid,
a fermentable sugar,
plant proteins,
and said shelf-stable plant-based fermented dairy drink analogue has:
a pH of 3.0 to 5.0, preferably of 3.5 to 4.5, from 0.5 wt. % to 3.4 wt. % of plant protein, and
a shelf-life of at least 3 months at a temperature of 20° C. to 40° C.

13. A shelf-stable plant-based fermented dairy drink analogue according to claim 12, which has a viscosity of at least 50 mPa·s at 100 s−1 at 10° C., measured by means of a rheometer with plate-plate geometry (60 mm diameter) and with 1 mm gap.

14-15. (canceled)
